(19) United States
(12) Patent Application Publication
(10) Pub. No.: US 2023/0064714 A1
(43) Pub. Date: Mar. 2, 2023

(54) DYNAMIC ALARMS BASED ON REMOTE MOVING OBJECTS

(71) Applicant: QUALCOMM Incorporated, San Diego, CA (US)

(72) Inventors: Chinna Lakshman PARA, Hyderabad (IN); Siva Ramesh Kumar ANDEY, Hyderabad (IN); Venkata Raghunath VEMURI, Hyderabad (IN); Ashray ACHARY, Hyderabad (IN)

(21) Appl. No.: 17/796,341

(22) PCT Filed: Feb. 15, 2021
(86) PCT No.: PCT/US2021/018107

§ 371 Date: Jul. 29, 2022

(30) Foreign Application Priority Data
Feb. 25, 2020 (IN) 202041007986

(51) Int. Cl. G06Q 10/06; H04W 4/029

(52) U.S. Cl. CPC G06Q 10/06311; H04W 4/029; G01C 21/3438

(57) ABSTRACT

Techniques for generating dynamic alarms on a mobile device are provided. An example method of providing a dynamic alarm with a mobile device includes receiving initial dynamic alarm information and event information via a first user interface, obtaining an event information update, calculating an alarm time modification based on the event information update, and activating a device alarm based at least in part on the initial dynamic alarm information and the alarm time modification.

### BACKGROUND

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service, a fourth-generation (4G) service (e.g., Long Term Evolution (LTE) or WiMax), and fifth-generation (5G NR) service. There are presently many different types of wireless communication systems in use, including Cellular and Personal Communications Service (PCS) systems. Examples of known cellular systems include the cellular Analog Advanced Mobile Phone System (AMPS), and digital cellular systems based on Code Division Multiple Access (CDMA), Frequency Division Multiple Access (FDMA), Time Division Multiple Access (TDMA), the Global System for Mobile access (GSM) variation of TDMA, etc.

It is often desirable to know the location of a user equipment (UE), e.g., a cellular phone, with the terms “location” and “position” being synonymous and used interchangeably herein. A location services (LCS) client may desire to know the location of the UE and may communicate with a location center in order to request the location of the UE. The location center and the UE may exchange messages, as appropriate, to obtain a location estimate for the UE. The location center may return the location estimate to the LCS client, e.g., for use in one or more applications.

Obtaining the location of a mobile device that is accessing a wireless network may be useful for many applications including, for example, emergency calls, personal navigation, asset tracking, locating a friend or family member, etc. Existing positioning methods include methods based on measuring radio signals transmitted from a variety of devices including satellite vehicles and terrestrial radio sources in a wireless network such as base stations and access points.

### SUMMARY

An example method of providing a dynamic alarm with a mobile device according to the disclosure includes receiving initial dynamic alarm information and event information via a first user interface, obtaining an event information update, calculating an alarm time modification based on the event information update, and activating a device alarm based at least in part on the initial dynamic alarm information and the alarm time modification.

Implementations of such a method may include one or more of the following features. The event information may include identification information associated with a second user. The event information may include an indication of a rendezvous location. An estimated travel time from a location of a first device associated with a first user to the rendezvous location may be determined, such that the alarm time modification is based in part on the estimated travel time. The event information may include vehicle-tracking information associated with a vehicle. The event information may be associated with a schedule object in a schedule management application. The event information update may include an estimated time of arrival based on a current location of a second device associated with a second user. The event information update may include an estimated time of arrival for a vehicle. The event information update may include a schedule change in a schedule object in a schedule management application. Calculating the alarm time modification may include adding a preparation time value. Calculating the alarm time modification may include calculating a snooze time value based on the initial dynamic alarm information and the event information update, and wherein activating the device alarm includes providing a snooze option via the first user interface based on the snooze time value. Activating the device alarm may include sending a command to one or more internet of things (IoT) devices.

An example apparatus according to the disclosure includes a memory, at least one processor operably coupled to the memory and configured to receive initial dynamic alarm information and event information via a first user interface, obtain an event information update, calculate an alarm time modification based on the event information update, and activate a device alarm based at least in part on the initial dynamic alarm information and the alarm time modification.

Implementations of such an apparatus may include one or more of the following features. The at least one processor may be further configured to determine an estimated travel time from a location of a first device associated with a first user to the rendezvous location, wherein the alarm time modification is based in part on the estimated travel time. The at least one processor may be further configured to calculate a snooze time value based on the initial dynamic alarm information and the event information update and provide a snooze option to a user based on the snooze time value.

An example apparatus for providing a dynamic alarm according to the disclosure includes means for receiving initial dynamic alarm information and event information via a first user interface, means for obtaining an event information update, means for calculating an alarm time modification based on the event information update, and means for activating a device alarm based at least in part on the initial dynamic alarm information and the alarm time modification.

An example non-transitory processor-readable storage medium comprising processor-readable instructions to cause one or more processors to provide a dynamic alarm according to the disclosure includes code for receiving initial dynamic alarm information and event information via a first user interface, code for obtaining an event information update, code for calculating an alarm time modification based on the event information update, and code for activating a device alarm based at least in part on the initial dynamic alarm information and the alarm time modification.

An example method of providing a dynamic alarm according to the disclosure includes receiving an event time, an event location and one or more event tasks via a user interface, determining event task locations for the one or more event tasks, calculating route information based at least on the event time, the event location, and the event task locations, calculating an alarm time based at least in part on the route information, and activating a device alarm based on the alarm time.

Implementations of such a method may include one or more of the following features. The one or more event tasks may include an item and determining the event task locations includes determining a location associated with the item. Receiving the one or more event tasks via the user interface may include receiving one or more event tasks from an invitation management application that are assigned to a user. Calculating the route information may include receiving estimated travel times from a route planning application based on the event time, the event location and the event task locations. One or more of the event task locations may be associated with a duration time and calculating the alarm time may be based at least in part on the route information and the duration time. Activating the device alarm may include providing the alarm time to an alarm field to a schedule object in a schedule management application.

An example apparatus according to the disclosure includes a memory, at least one processor operably coupled to the memory and configured to receive an event time, an event location and one or more event tasks via a user interface, determine event task locations for the one or more event tasks, calculate route information based at least on the event time, the event location, and the event task locations, calculate an alarm time based at least in part on the route information, and activate a device alarm based on the alarm time.

Implementations of such an apparatus may include one or more of the following features. The at least one processor may be further configured to receive the one or more event tasks from an invitation management application that are assigned to a user. The at least one processor may be further configured to receive estimated travel times from a route planning application based on the event time, the event location and the event task locations. The at least one processor may be further configured to provide the alarm time to an alarm field to a schedule object in a schedule management application.

An example for providing a dynamic alarm according to the disclosure includes means for receiving an event time, an event location and one or more event tasks via a user interface, means for determining event task locations for the one or more event tasks, means for calculating route information based at least on the event time, the event location, and the event task locations, means for calculating an alarm time based at least in part on the route information, and means for activating a device alarm based on the alarm time.

An example non-transitory processor-readable storage medium comprising processor-readable instructions configured to cause one or more processors to provide a dynamic alarm according to the disclosure includes code for receiving an event time, an event location and one or more event tasks via a user interface, code for determining event task locations for the one or more event tasks, code for calculating route information based at least on the event time, the event location, and the event task locations, code for calculating an alarm time based at least in part on the route information, and code for activating a device alarm based on the alarm time.

### BRIEF DESCRIPTION OF THE DRAWINGS

FIG. 1 is a simplified diagram of an example wireless communications system.

FIG. 2 is a block diagram of components of an example user equipment shown in FIG. 1.

FIG. 3 is a block diagram of components of an example transmission/reception point shown in FIG. 1.

FIG. 4 is a block diagram of components of an example server shown in FIG. 1.

FIG. 5A is an example use case diagram for a dynamic alarm based on a location of a mobile user.

FIG. 5B is an example user interface on a mobile device for entering a dynamic alarm.

FIG. 6 is an example use case diagram for a dynamic alarm based on web server data.

FIG. 7 is an example use case diagram for a dynamic alarm based on schedule updates.

FIG. 8 is an example use case diagram for a dynamic alarm based on an event task list.

FIG. 9 is a block flow diagram of an example method for determining a dynamic alarm.

FIG. 10 is a block flow diagram of an example method for calculating a dynamic alarm based on route information.

### DETAILED DESCRIPTION

Techniques are discussed herein for providing dynamic alarms on a mobile device. A typical alarm on a mobile device (e.g., hand-held, wearable device) may be triggered at a set date and time. In general, the trigger time of the alarm is static and is not updated unless a user manually edits the date and/or time. For example, a user may set an alarm on his wearable device to trigger at early hours to be able to receive a friend arriving on a long-distance bus. In reality, due to unexpected multiple traffic congestions, the bus may be running late and its estimated time of arrival (ETA) may be delayed 45 mins. Since the user set alarm is triggered at a set time, the user may be unnecessarily alerted 45 mins early. The dynamic alarms as described herein, however, may be updated based on external events without the need for intervention from the user.

In an example, a dynamic alarm may be realized based on the distances between a first location, a location of a mobile device, and a target destination. A dynamic alarm may be modified based on the estimated time the mobile device will arrive at the target destination. For example, positioning information such as terrestrial and satellite navigation signals may be used to determine the distances and estimate the time of arrival. A user at the first location may set an initial alarm on an electronic device based on the time the mobile device is expected to arrive at the target destination. The progress of the mobile device may change due to traffic, weather, mechanical breakdown, or other reasons. The mobile device may utilize its current position and other sensor data to provide an updated ETA to the electronic device. The ETA may be provided to, or computed by, other network resources configured to communicate with the electronic device. In an example, the electronic device at the first location may update an alarm time based on the updated ETA. In another example, the alarm on the electronic device may have a snooze function and the snooze time may be updated based on the updated ETA. In an example, the ETA of the mobile device may be based on a networked vehicle-tracking system (e.g., flight tracker), and the updated ETA may be available to the electronic device for updating the alarm and/or snooze times. These techniques and configurations are examples, and other techniques and configurations may be used.

Items and/or techniques described herein may provide one or more of the following capabilities, as well as other capabilities not mentioned. A dynamic alarm may be entered into a mobile device. The dynamic alarm may be associated with a mobile user, a vehicle or an event. Schedule changes associated with the mobile user, vehicle or event may be detected by the mobile device. The dynamic alarm may be updated based on the schedule changes. A snooze time function may be updated based on the schedule changes. Other capabilities may be provided and not every implementation according to the disclosure must provide any, let alone all, of the capabilities discussed.

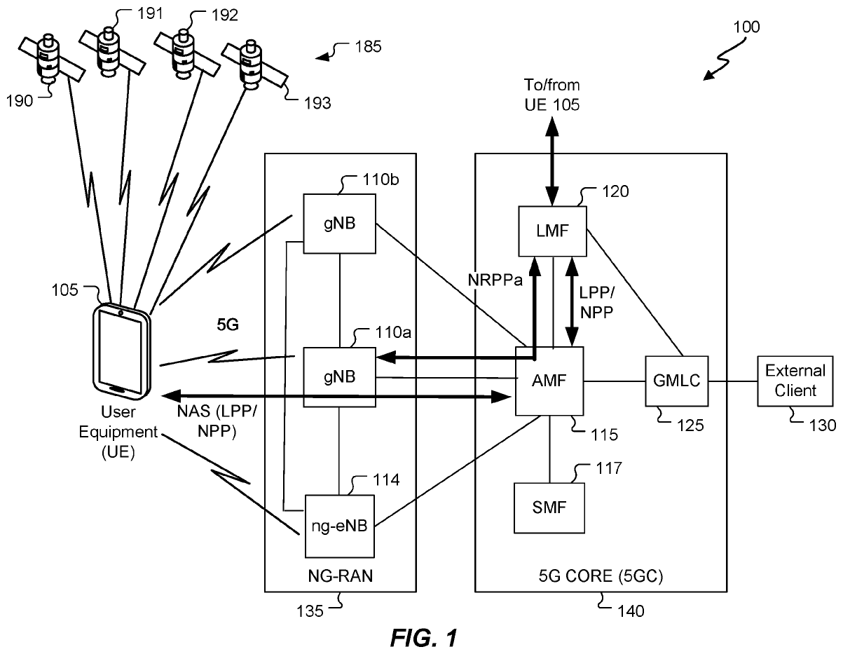

Referring to FIG. 1, an example of a communication system 100 includes a UE 105, a Radio Access Network (RAN) 135, here a Fifth Generation (5G) Next Generation (NG) RAN (NG-RAN), and a 5G Core Network (5GC) 140. The UE 105 may be, e.g., an IoT device, a location tracker device, a cellular telephone, or other device. A 5G network may also be referred to as a New Radio (NR) network; NG-RAN 135 may be referred to as a 5G RAN or as an NR RAN; and 5GC 140 may be referred to as an NG Core network (NGC). Standardization of an NG-RAN and 5GC is ongoing in the 3^{rd} Generation Partnership Project (3GPP). Accordingly, the NG-RAN 135 and the 5GC 140 may conform to current or future standards for 5G support from 3GPP. The RAN 135 may be another type of RAN, e.g., a 3G RAN, a 4G Long Term Evolution (LTE) RAN, etc. The communication system 100 may utilize information from a constellation 185 of satellite vehicles (SVs) 190, 191, 192, 193 for a Satellite Positioning System (SPS) (e.g., a Global Navigation Satellite System (GNSS)) like the Global Positioning System (GPS), the Global Navigation Satellite System (GLONASS), Galileo, or Beidou or some other local or regional SPS such as the Indian Regional Navigational Satellite System (IRNSS), the European Geostationary Navigation Overlay Service (EGNOS), or the Wide Area Augmentation System (WAAS). Additional components of the communication system 100 are described below. The communication system 100 may include additional or alternative components.

As shown in FIG. 1, the NG-RAN 135 includes NR nodeBs (gNBs) 110a, 110b, and a next generation eNodeB (ng-eNB) 114, and the 5GC 140 includes an Access and Mobility Management Function (AMF) 115, a Session Management Function (SMF) 117, a Location Management Function (LMF) 120, and a Gateway Mobile Location Center (GMLC) 125. The gNBs 110a, 110b and the ng-eNB 114 are communicatively coupled to each other, are each configured to bi-directionally wirelessly communicate with the UE 105, and are each communicatively coupled to, and configured to bi-directionally communicate with, the AMF 115. The AMF 115, the SMF 117, the LMF 120, and the GMLC 125 are communicatively coupled to each other, and the GMLC is communicatively coupled to an external client 130. The SMF 117 may serve as an initial contact point of a Service Control Function (SCF) (not shown) to create, control, and delete media sessions.

FIG. 1 provides a generalized illustration of various components, any or all of which may be utilized as appropriate, and each of which may be duplicated or omitted as necessary. Specifically, although only one UE 105 is illustrated, many UEs (e.g., hundreds, thousands, millions, etc.) may be utilized in the communication system 100. Similarly, the communication system 100 may include a larger (or smaller) number of SVs (i.e., more or fewer than the four SVs 190-193 shown), gNBs 110a, 100b, ng-eNBs 114, AMFs 115, external clients 130, and/or other components. The illustrated connections that connect the various components in the communication system 100 include data and signaling connections which may include additional (intermediary) components, direct or indirect physical and/or wireless connections, and/or additional networks. Furthermore, components may be rearranged, combined, separated, substituted, and/or omitted, depending on desired functionality.

While FIG. 1 illustrates a 5G-based network, similar network implementations and configurations may be used for other communication technologies, such as 3G, Long Term Evolution (LTE), etc. Implementations described herein (be they for 5G technology and/or for one or more other communication technologies and/or protocols) may be used to transmit (or broadcast) directional synchronization signals, receive and measure directional signals at UEs (e.g., the UE 105) and/or provide location assistance to the UE 105 (via the GMLC 125 or other location server) and/or compute a location for the UE 105 at a location-capable device such as the UE 105, the gNB 110a, 110b, or the LMF 120 based on measurement quantities received at the UE 105 for such directionally-transmitted signals. The gateway mobile location center (GMLC) 125, the location management function (LMF) 120, the access and mobility management function (AMF) 115, the SMF 117, the ng-eNB (eNodeB) 114 and the gNBs (gNodeBs) 110a, 110b are examples and may, in various embodiments, be replaced by or include various other location server functionality and/or base station functionality respectively.

The UE 105 may comprise and/or may be referred to as a device, a mobile device, a wireless device, a mobile terminal, a terminal, a mobile station (MS), a Secure User Plane Location (SUPL) Enabled Terminal (SET), or by some other name. Moreover, the UE 105 may correspond to a cellphone, smartphone, laptop, tablet, PDA, vehicle-tracking device, navigation device, Internet of Things (IoT) device, asset tracker, health monitors, security systems, smart city sensors, smart meters, wearable trackers, or some other portable or moveable device. Typically, though not necessarily, the UE 105 may support wireless communication using one or more Radio Access Technologies (RATs) such as Global System for Mobile communication (GSM), Code Division Multiple Access (CDMA), Wideband CDMA (WCDMA), LTE, High Rate Packet Data (HRPD), IEEE 802.11 WiFi (also referred to as Wi-Fi), Bluetooth® (BT), Worldwide Interoperability for Microwave Access (WiMAX), 5G new radio (NR) (e.g., using the NG-RAN 135 and the 5GC 140), etc. The UE 105 may support wireless communication using a Wireless Local Area Network (WLAN) which may connect to other networks (e.g., the Internet) using a Digital Subscriber Line (DSL) or packet cable, for example. The use of one or more of these RATs may allow the UE 105 to communicate with the external client 130 (e.g., via elements of the 5GC 140 not shown in FIG. 1, or possibly via the GMLC 125) and/or allow the external client 130 to receive location information regarding the UE 105 (e.g., via the GMLC 125).

The UE 105 may include a single entity or may include multiple entities such as in a personal area network where a user may employ audio, video and/or data I/O (input/output) devices and/or body sensors and a separate wireline or wireless modem. An estimate of a location of the UE 105 may be referred to as a location, location estimate, location fix, fix, position, position estimate, or position fix, and may be geographic, thus providing location coordinates for the UE 105 (e.g., latitude and longitude) which may or may not include an altitude component (e.g., height above sea level, height above or depth below ground level, floor level, or basement level). Alternatively, a location of the UE 105 may be expressed as a civic location (e.g., as a postal address or the designation of some point or small area in a building such as a particular room or floor). A location of the UE 105 may be expressed as an area or volume (defined either geographically or in civic form) within which the UE 105 is expected to be located with some probability or confidence level (e.g., 67%, 95%, etc.). A location of the UE 105 may be expressed as a relative location comprising, for example, a distance and direction from a known location. The relative location may be expressed as relative coordinates (e.g., X, Y (and Z) coordinates) defined relative to some origin at a known location which may be defined, e.g., geographically, in civic terms, or by reference to a point, area, or volume, e.g., indicated on a map, floor plan, or building plan. In the description contained herein, the use of the term location may comprise any of these variants unless indicated otherwise. When computing the location of a UE, it is common to solve for local x, y, and possibly z coordinates and then, if desired, convert the local coordinates into absolute coordinates (e.g., for latitude, longitude, and altitude above or below mean sea level).

The UE 105 may be configured to communicate with other entities using one or more of a variety of technologies. The UE 105 may be configured to connect indirectly to one or more communication networks via one or more device-to-device (D2D) peer-to-peer (P2P) links. The D2D P2P links may be supported with any appropriate D2D radio access technology (RAT), such as LTE Direct (LTE-D), WiFi Direct (WiFi-D), Bluetooth®, and so on. One or more of a group of UEs utilizing D2D communications may be within a geographic coverage area of a Transmission/Reception Point (TRP) such as one or more of the gNBs 110a, 110b, and/or the ng-eNB 114. Other UEs in such a group may be outside such geographic coverage areas or may be otherwise unable to receive transmissions from a base station. Groups of UEs communicating via D2D communications may utilize a one-to-many (1:M) system in which each UE may transmit to other UEs in the group. A TRP may facilitate scheduling of resources for D2D communications. In other cases, D2D communications may be carried out between UEs without the involvement of a TRP.

Base stations (BSs) in the NG-RAN 135 shown in FIG. 1 include NR Node Bs, referred to as the gNBs 110a and 110b. Pairs of the gNBs 110a, 110b in the NG-RAN 135 may be connected to one another via one or more other gNBs. Access to the 5G network is provided to the UE 105 via wireless communication between the UE 105 and one or more of the gNBs 110a, 110b, which may provide wireless communications access to the 5GC 140 on behalf of the UE 105 using 5G. In FIG. 1, the serving gNB for the UE 105 is assumed to be the gNB 110a, although another gNB (e.g. the gNB 110b) may act as a serving gNB if the UE 105 moves to another location or may act as a secondary gNB to provide additional throughput and bandwidth to the UE 105.

Base stations (BSs) in the NG-RAN 135 shown in FIG. 1 may include the ng-eNB 114, also referred to as a next generation evolved Node B. The ng-eNB 114 may be connected to one or more of the gNBs 110a, 110b in the NG-RAN 135, possibly via one or more other gNBs and/or one or more other ng-eNBs. The ng-eNB 114 may provide LTE wireless access and/or evolved LTE (eLTE) wireless access to the UE 105. One or more of the gNBs 110a, 110b and/or the ng-eNB 114 may be configured to function as positioning-only beacons which may transmit signals to assist with determining the position of the UE 105 but may not receive signals from the UE 105 or from other UEs.

The BSs 110a, 110b, 114 may each comprise one or more TRPs. For example, each sector within a cell of a BS may comprise a TRP, although multiple TRPs may share one or more components (e.g., share a processor but have separate antennas). The system 100 may include only macro TRPs or the system 100 may have TRPs of different types, e.g., macro, pico, and/or femto TRPs, etc. A macro TRP may cover a relatively large geographic area (e.g., several kilometers in radius) and may allow unrestricted access by terminals with service subscription. A pico TRP may cover a relatively small geographic area (e.g., a pico cell) and may allow unrestricted access by terminals with service subscription. A femto or home TRP may cover a relatively small geographic area (e.g., a femto cell) and may allow restricted access by terminals having association with the femto cell (e.g., terminals for users in a home).

As noted, while FIG. 1 depicts nodes configured to communicate according to 5G communication protocols, nodes configured to communicate according to other communication protocols, such as, for example, an LTE protocol or IEEE 802.11x protocol, may be used. For example, in an Evolved Packet System (EPS) providing LTE wireless access to the UE 105, a RAN may comprise an Evolved Universal Mobile Telecommunications System (UMTS) Terrestrial Radio Access Network (E-UTRAN) which may comprise base stations comprising evolved Node Bs (eNBs). A core network for EPS may comprise an Evolved Packet Core (EPC). An EPS may comprise an E-UTRAN plus EPC, where the E-UTRAN corresponds to the NG-RAN 135 and the EPC corresponds to the 5GC 140 in FIG. 1.

The gNBs 110a, 110b and the ng-eNB 114 may communicate with the AMF 115, which, for positioning functionality, communicates with the LMF 120. The AMF 115 may support mobility of the UE 105, including cell change and handover and may participate in supporting a signaling connection to the UE 105 and possibly data and voice bearers for the UE 105. The LMF 120 may communicate directly with the UE 105, e.g., through wireless communications. The LMF 120 may support positioning of the UE 105 when the UE 105 accesses the NG-RAN 135 and may support position procedures/methods such as Assisted GNSS (A-GNSS), Observed Time Difference of Arrival (OTDOA), Real Time Kinematics (RTK), Precise Point Positioning (PPP), Differential GNSS (DGNSS), Enhanced Cell ID (E-CID), angle of arrival (AOA), angle of departure (AOD), and/or other position methods. The LMF 120 may process location services requests for the UE 105, e.g., received from the AMF 115 or from the GMLC 125. The LMF 120 may be connected to the AMF 115 and/or to the GMLC 125. The LMF 120 may be referred to by other names such as a Location Manager (LM), Location Function (LF), commercial LMF (CLMF), or value added LMF (VLMF). A node/system that implements the LMF 120 may additionally or alternatively implement other types of location-support modules, such as an Enhanced Serving Mobile Location Center (E-SMLC) or a Secure User Plane Location (SUPL) Location Platform (SLP). At least part of the positioning functionality (including derivation of the location of the UE 105) may be performed at the UE 105 (e.g., using signal measurements obtained by the UE 105 for signals transmitted by wireless nodes such as the gNBs 110a, 110b and/or the ng-eNB 114, and/or assistance data provided to the UE 105, e.g. by the LMF 120).

The GMLC 125 may support a location request for the UE 105 received from the external client 130 and may forward such a location request to the AMF 115 for forwarding by the AMF 115 to the LMF 120 or may forward the location request directly to the LMF 120. A location response from the LMF 120 (e.g., containing a location estimate for the UE 105) may be returned to the GMLC 125 either directly or via the AMF 115 and the GMLC 125 may then return the location response (e.g., containing the location estimate) to the external client 130. The GMLC 125 is shown connected to both the AMF 115 and LMF 120, though only one of these connections may be supported by the 5GC 140 in some implementations.

As further illustrated in FIG. 1, the LMF 120 may communicate with the gNBs 110a, 110b and/or the ng-eNB 114 using a New Radio Position Protocol A (which may be referred to as NPPa or NRPPa), which may be defined in 3GPP Technical Specification (TS) 38.455. NRPPa may be the same as, similar to, or an extension of the LTE Positioning Protocol A (LPPa) defined in 3GPP TS 36.455, with NRPPa messages being transferred between the gNB 110a (or the gNB 110b) and the LMF 120, and/or between the ng-eNB 114 and the LMF 120, via the AMF 115. As further illustrated in FIG. 1, the LMF 120 and the UE 105 may communicate using an LTE Positioning Protocol (LPP), which may be defined in 3GPP TS 36.355. The LMF 120 and the UE 105 may also or instead communicate using a New Radio Positioning Protocol (which may be referred to as NPP or NRPP), which may be the same as, similar to, or an extension of LPP. Here, LPP and/or NPP messages may be transferred between the UE 105 and the LMF 120 via the AMF 115 and the serving gNB 110a, 110b or the serving ng-eNB 114 for the UE 105. For example, LPP and/or NPP messages may be transferred between the LMF 120 and the AMF 115 using a 5G Location Services Application Protocol (LCS AP) and may be transferred between the AMF 115 and the UE 105 using a 5G Non-Access Stratum (NAS) protocol. The LPP and/or NPP protocol may be used to support positioning of the UE 105 using UE-assisted and/or UE-based position methods such as A-GNSS, RTK, OTDOA and/or E-CID. The NRPPa protocol may be used to support positioning of the UE 105 using network-based position methods such as E-CID (e.g., when used with measurements obtained by the gNB 110a, 110b or the ng-eNB 114) and/or may be used by the LMF 120 to obtain location related information from the gNBs 110a, 110b and/or the ng-eNB 114, such as parameters defining directional SS transmissions from the gNBs 110a, 110b, and/or the ng-eNB 114.

With a UE-assisted position method, the UE 105 may obtain location measurements and send the measurements to a location server (e.g., the LMF 120) for computation of a location estimate for the UE 105. For example, the location measurements may include one or more of a Received Signal Strength Indication (RSSI), Round Trip signal propagation Time (RTT), Reference Signal Time Difference (RSTD), Reference Signal Received Power (RSRP) and/or Reference Signal Received Quality (RSRQ) for the gNBs 110a, 110b, the ng-eNB 114, and/or a WLAN AP. The location measurements may also or instead include measurements of GNSS pseudorange, code phase, and/or carrier phase for the SVs 190-193.

With a UE-based position method, the UE 105 may obtain location measurements (e.g., which may be the same as or similar to location measurements for a UE-assisted position method) and may compute a location of the UE 105 (e.g., with the help of assistance data received from a location server such as the LMF 120 or broadcast by the gNBs 110a, 110b, the ng-eNB 114, or other base stations or APs).

With a network-based position method, one or more base stations (e.g., the gNBs 110a, 110b, and/or the ng-eNB 114) or APs may obtain location measurements (e.g., measurements of RSSI, RTT, RSRP, RSRQ or Time Of Arrival (TOA) for signals transmitted by the UE 105) and/or may receive measurements obtained by the UE 105. The one or more base stations or APs may send the measurements to a location server (e.g., the LMF 120) for computation of a location estimate for the UE 105.

Information provided by the gNBs 110a, 110b, and/or the ng-eNB 114 to the LMF 120 using NRPPa may include timing and configuration information for directional SS transmissions and location coordinates. The LMF 120 may provide some or all of this information to the UE 105 as assistance data in an LPP and/or NPP message via the NG-RAN 135 and the 5GC 140.

An LPP or NPP message sent from the LMF 120 to the UE 105 may instruct the UE 105 to do any of a variety of things depending on desired functionality. For example, the LPP or NPP message could contain an instruction for the UE 105 to obtain measurements for GNSS (or A-GNSS), WLAN, E-CID, and/or OTDOA (or some other position method). In the case of E-CID, the LPP or NPP message may instruct the UE 105 to obtain one or more measurement quantities (e.g., beam ID, beam width, mean angle, RSRP, RSRQ measurements) of directional signals transmitted within particular cells supported by one or more of the gNBs 110a, 110b, and/or the ng-eNB 114 (or supported by some other type of base station such as an eNB or WiFi AP). The UE 105 may send the measurement quantities back to the LMF 120 in an LPP or NPP message (e.g., inside a 5G NAS message) via the serving gNB 110a (or the serving ng-eNB 114) and the AMF 115.

As noted, while the communication system 100 is described in relation to 5G technology, the communication system 100 may be implemented to support other communication technologies, such as GSM, WCDMA, LTE, etc., that are used for supporting and interacting with mobile devices such as the UE 105 (e.g., to implement voice, data, positioning, and other functionalities). In some such embodiments, the 5GC 140 may be configured to control different air interfaces. For example, the 5GC 140 may be connected to a WLAN using a Non-3GPP InterWorking Function (N3IWF, not shown FIG. 1) in the 5GC 150. For example, the WLAN may support IEEE 802.11 WiFi access for the UE 105 and may comprise one or more WiFi APs. Here, the N3IWF may connect to the WLAN and to other elements in the 5GC 140 such as the AMF 115. In some embodiments, both the NG-RAN 135 and the 5GC 140 may be replaced by one or more other RANs and one or more other core networks. For example, in an EPS, the NG-RAN 135 may be replaced by an E-UTRAN containing eNBs and the 5GC 140 may be replaced by an EPC containing a Mobility Management Entity (MME) in place of the AMF 115, an E-SMLC in place of the LMF 120, and a GMLC that may be similar to the GMLC 125. In such an EPS, the E-SMLC may use LPPa in place of NRPPa to send and receive location information to and from the eNBs in the E-UTRAN and may use LPP to support positioning of the UE 105. In these other embodiments, positioning of the UE 105 using directional PRSs may be supported in an analogous manner to that described herein for a 5G network with the difference that functions and procedures described herein for the gNBs 110a, 110b, the ng-eNB 114, the AMF 115, and the LMF 120 may, in some cases, apply instead to other network elements such eNBs, WiFi APs, an MME, and an E-SMLC.

As noted, in some embodiments, positioning functionality may be implemented, at least in part, using the directional SS beams, sent by base stations (such as the gNBs 110a, 110b, and/or the ng-eNB 114) that are within range of the UE whose position is to be determined (e.g., the UE 105 of FIG. 1). The UE may, in some instances, use the directional SS beams from a plurality of base stations (such as the gNBs 110a, 110b, the ng-eNB 114, etc.) to compute the UE's position.

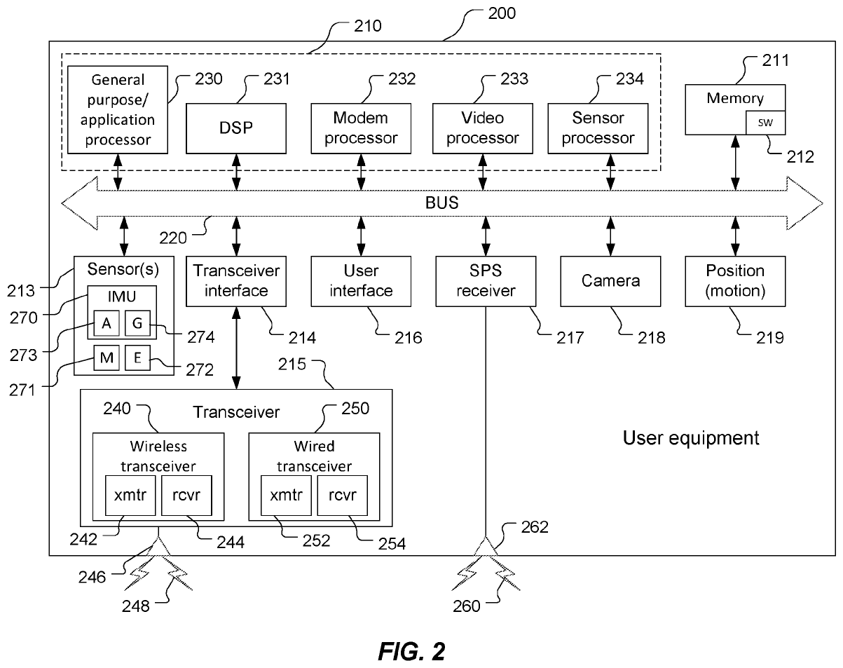

Referring also to FIG. 2, a UE 200 is an example of the UE 105 and comprises a computing platform including a processor 210, memory 211 including software (SW) 212, one or more sensors 213, a transceiver interface 214 for a transceiver 215, a user interface 216, a Satellite Positioning System (SPS) receiver 217, a camera 218, and a position (motion) device 219. The processor 210, the memory 211, the sensor(s) 213, the transceiver interface 214, the user interface 216, the SPS receiver 217, the camera 218, and the position (motion) device 219 may be communicatively coupled to each other by a bus 220 (which may be configured, e.g., for optical and/or electrical communication). One or more of the shown apparatus (e.g., the camera 218, the position (motion) device 219, and/or one or more of the sensor(s) 213, etc.) may be omitted from the UE 200. The processor 210 may include one or more intelligent hardware devices, e.g., a central processing unit (CPU), a microcontroller, an application specific integrated circuit (ASIC), etc. The processor 210 may comprise multiple processors including a general-purpose/application processor 230, a Digital Signal Processor (DSP) 231, a modem processor 232, a video processor 233, and/or a sensor processor 234. One or more of the processors 230-234 may comprise multiple devices (e.g., multiple processors). For example, the sensor processor 234 may comprise, e.g., processors for radar, ultrasound, and/or lidar, etc. The modem processor 232 may support dual SIM/dual connectivity (or even more SIMs). For example, a SIM (Subscriber Identity Module or Subscriber Identification Module) may be used by an Original Equipment Manufacturer (OEM), and another SIM may be used by an end user of the UE 200 for connectivity. The memory 211 is a non-transitory storage medium that may include random access memory (RAM), flash memory, disc memory, and/or read-only memory (ROM), etc. The memory 211 stores the software 212 which may be processor-readable, processor-executable software code containing instructions that are configured to, when executed, cause the processor 210 to perform various functions described herein. Alternatively, the software 212 may not be directly executable by the processor 210 but may be configured to cause the processor 210, e.g., when compiled and executed, to perform the functions. The description may refer only to the processor 210 performing a function, but this includes other implementations such as where the processor 210 executes software and/or firmware. The description may refer to the processor 210 performing a function as shorthand for one or more of the processors 230-234 performing the function. The description may refer to the UE 200 performing a function as shorthand for one or more appropriate components of the UE 200 performing the function. The processor 210 may include a memory with stored instructions in addition to and/or instead of the memory 211. Functionality of the processor 210 is discussed more fully below.

The configuration of the UE 200 shown in FIG. 2 is an example and not limiting of the disclosure, including the claims, and other configurations may be used. For example, an example configuration of the UE includes one or more of the processors 230-234 of the processor 210, the memory 211, and the wireless transceiver 240. Other example configurations include one or more of the processors 230-234 of the processor 210, the memory 211, the wireless transceiver 240, and one or more of the sensor(s) 213, the user interface 216, the SPS receiver 217, the camera 218, the PMD 219, and/or the wired transceiver 250.

The UE 200 may comprise the modem processor 232 that may be capable of performing baseband processing of signals received and down converted by the transceiver 215 and/or the SPS receiver 217. The modem processor 232 may perform baseband processing of signals to be upconverted for transmission by the transceiver 215. Also, or alternatively, baseband processing may be performed by the processor 230 and/or the DSP 231. Other configurations, however, may be used to perform baseband processing.

The UE 200 may include the sensor(s) 213 that may include, for example, an Inertial Measurement Unit (IMU) 270, one or more magnetometers 271, and/or one or more environment sensors 272. The IMU 270 may comprise one or more inertial sensors, for example, one or more accelerometers 273 (e.g., collectively responding to acceleration of the UE 200 in three dimensions) and/or one or more gyroscopes 274 (e.g., three-dimensional gyroscope(s)). The magnetometer(s) may provide measurements to determine orientation (e.g., relative to magnetic north and/or true north) that may be used for any of a variety of purposes, e.g., to support one or more compass applications. The environment sensor(s) 272 may comprise, for example, one or more temperature sensors, one or more barometric pressure sensors, one or more ambient light sensors, one or more camera imagers, and/or one or more microphones, etc. The sensor(s) 213 may generate analog and/or digital signals indications of which may be stored in the memory 211 and processed by the DSP 231 and/or the processor 230 in support of one or more applications such as, for example, applications directed to positioning and/or navigation operations.

The sensor(s) 213 may be used in relative location measurements, relative location determination, motion determination, etc. Information detected by the sensor(s) 213 may be used for motion detection, relative displacement, dead reckoning, sensor-based location determination, and/or sensor-assisted location determination. The sensor(s) 213 may be useful to determine whether the UE 200 is fixed (stationary) or mobile and/or whether to report certain useful information to a location server such as the LMF 120 regarding the mobility of the UE 200. For example, based on the information obtained/measured by the sensor(s) 213, the UE 200 may notify/report to the LMF 120 that the UE 200 has detected movements or that the UE 200 has moved, and report the relative displacement/distance (e.g., via dead reckoning, or sensor-based location determination, or sensor-assisted location determination enabled by the sensor(s) 213). In another example, for relative positioning information, the sensors/IMU can be used to determine the angle and/or orientation of the other device with respect to the UE 200, etc.

The IMU 270 may be configured to provide measurements about a direction of motion and/or a speed of motion of the UE 200, which may be used in relative location determination. For example, the one or more accelerometers 273 and/or the one or more gyroscopes 274 of the IMU 270 may detect, respectively, a linear acceleration and a speed of rotation of the UE 200. The linear acceleration and speed of rotation measurements of the UE 200 may be integrated over time to determine an instantaneous direction of motion as well as a displacement of the UE 200. The instantaneous direction of motion and the displacement may be integrated to track a location of the UE 200. For example, a reference location of the UE 200 may be determined, e.g., using the SPS receiver 217 (and/or by some other means) for a moment in time and measurements from the accelerometer(s) 273 and gyroscope(s) 274 taken after this moment in time may be used in dead reckoning to determine present location of the UE 200 based on movement (direction and distance) of the UE 200 relative to the reference location.

The magnetometer(s) 271 may determine magnetic field strengths in different directions which may be used to determine orientation of the UE 200. For example, the orientation may be used to provide a digital compass for the UE 200. The magnetometer(s) 271 may include a two-dimensional magnetometer configured to detect and provide indications of magnetic field strength in two orthogonal dimensions. Also, or alternatively, the magnetometer(s) 271 may include a three-dimensional magnetometer configured to detect and provide indications of magnetic field strength in three orthogonal dimensions. The magnetometer(s) 271 may provide means for sensing a magnetic field and providing indications of the magnetic field, e.g., to the processor 210.

The transceiver 215 may include a wireless transceiver 240 and a wired transceiver 250 configured to communicate with other devices through wireless connections and wired connections, respectively. For example, the wireless transceiver 240 may include a transmitter 242 and receiver 244 coupled to one or more antennas 246 for transmitting (e.g., on one or more uplink channels and/or one or more sidelink channels) and/or receiving (e.g., on one or more downlink channels, and/or one or more sidelink channels) wireless signals 248 and transducing signals from the wireless signals 248 to wired (e.g., electrical and/or optical) signals and from wired (e.g., electrical and/or optical) signals to the wireless signals 248. Thus, the transmitter 242 may include multiple transmitters that may be discrete components or combined/integrated components, and/or the receiver 244 may include multiple receivers that may be discrete components or combined/integrated components. The wireless transceiver 240 may be configured to communicate signals (e.g., with TRPs and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. New Radio may use mm-wave frequencies and/or sub-6 GHz frequencies. The wired transceiver 250 may include a transmitter 252 and a receiver 254 configured for wired communication, e.g., with the network 135 to send communications to, and receive communications from, the gNB 110a, for example. The transmitter 252 may include multiple transmitters that may be discrete components or combined/integrated components, and/or the receiver 254 may include multiple receivers that may be discrete components or combined/integrated components. The wired transceiver 250 may be configured, e.g., for optical communication and/or electrical communication. The transceiver 215 may be communicatively coupled to the transceiver interface 214, e.g., by optical and/or electrical connection. The transceiver interface 214 may be at least partially integrated with the transceiver 215.

The user interface 216 may comprise one or more of several devices such as, for example, a speaker, microphone, display device, vibration device, keyboard, touch screen, etc. The user interface 216 may include more than one of any of these devices. The user interface 216 may be configured to enable a user to interact with one or more applications hosted by the UE 200. For example, the user interface 216 may store indications of analog and/or digital signals in the memory 211 to be processed by DSP 231 and/or the general-purpose processor 230 in response to action from a user. Similarly, applications hosted on the UE 200 may store indications of analog and/or digital signals in the memory 211 to present an output signal to a user. The user interface 216 may include an audio input/output (I/O) device comprising, for example, a speaker, a microphone, digital-to-analog circuitry, analog-to-digital circuitry, an amplifier and/or gain control circuitry (including more than one of any of these devices). Other configurations of an audio I/O device may be used. Also, or alternatively, the user interface 216 may comprise one or more touch sensors responsive to touching and/or pressure, e.g., on a keyboard and/or touch screen of the user interface 216.

The SPS receiver 217 (e.g., a Global Positioning System (GPS) receiver) may be capable of receiving and acquiring SPS signals 260 via an SPS antenna 262. The antenna 262 is configured to transduce the wireless signals 260 to wired signals, e.g., electrical or optical signals, and may be integrated with the antenna 246. The SPS receiver 217 may be configured to process, in whole or in part, the acquired SPS signals 260 for estimating a location of the UE 200. For example, the SPS receiver 217 may be configured to determine location of the UE 200 by trilateration using the SPS signals 260. The general-purpose processor 230, the memory 211, the DSP 231 and/or one or more specialized processors (not shown) may be utilized to process acquired SPS signals, in whole or in part, and/or to calculate an estimated location of the UE 200, in conjunction with the SPS receiver 217. The memory 211 may store indications (e.g., measurements) of the SPS signals 260 and/or other signals (e.g., signals acquired from the wireless transceiver 240) for use in performing positioning operations. The general-purpose processor 230, the DSP 231, and/or one or more specialized processors, and/or the memory 211 may provide or support a location engine for use in processing measurements to estimate a location of the UE 200.

The UE 200 may include the camera 218 for capturing still or moving imagery. The camera 218 may comprise, for example, an imaging sensor (e.g., a charge coupled device or a CMOS imager), a lens, analog-to-digital circuitry, frame buffers, etc. Additional processing, conditioning, encoding, and/or compression of signals representing captured images may be performed by the general-purpose processor 230 and/or the DSP 231. Also, or alternatively, the video processor 233 may perform conditioning, encoding, compression, and/or manipulation of signals representing captured images. The video processor 233 may decode/decompress stored image data for presentation on a display device (not shown), e.g., of the user interface 216.

The position (motion) device (PMD) 219 may be configured to determine a position and possibly motion of the UE 200. For example, the PMD 219 may communicate with, and/or include some or all of, the SPS receiver 217. The PMD 219 may also or alternatively be configured to determine location of the UE 200 using terrestrial-based signals (e.g., at least some of the signals 248) for trilateration, for assistance with obtaining and using the SPS signals 260, or both. The PMD 219 may be configured to use one or more other techniques (e.g., relying on the UE's self-reported location (e.g., part of the UE's position beacon)) for determining the location of the UE 200, and may use a combination of techniques (e.g., SPS and terrestrial positioning signals) to determine the location of the UE 200. The PMD 219 may include one or more of the sensors 213 (e.g., gyroscope(s), accelerometer(s), magnetometer(s), etc.) that may sense orientation and/or motion of the UE 200 and provide indications thereof that the processor 210 (e.g., the processor 230 and/or the DSP 231) may be configured to use to determine motion (e.g., a velocity vector and/or an acceleration vector) of the UE 200. The PMD 219 may be configured to provide indications of uncertainty and/or error in the determined position and/or motion.

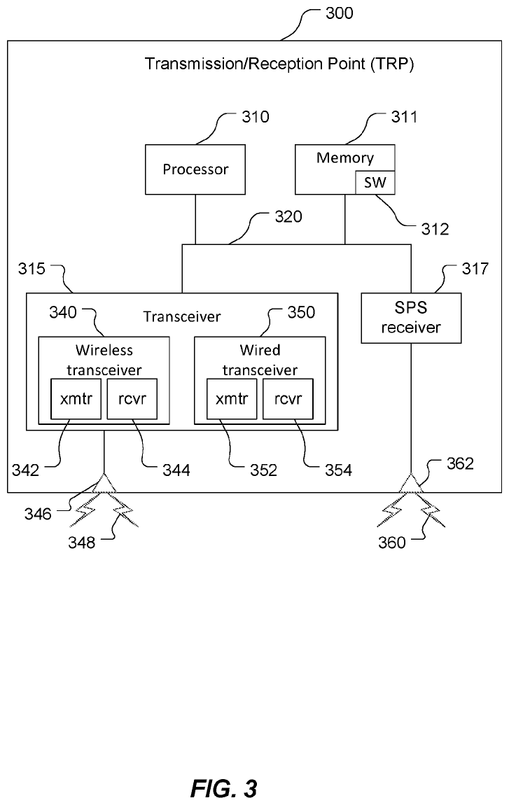

Referring also to FIG. 3, an example of a TRP 300 of the BSs 110a, 110b, 114 comprises a computing platform including a processor 310, memory 311 including software (SW) 312, a transceiver 315, and (optionally) an SPS receiver 317. The processor 310, the memory 311, the transceiver 315, and the SPS receiver 317 may be communicatively coupled to each other by a bus 320 (which may be configured, e.g., for optical and/or electrical communication). One or more of the shown apparatus (e.g., a wireless interface and/or the SPS receiver 317) may be omitted from the TRP 300. The SPS receiver 317 may be configured similarly to the SPS receiver 217 to be capable of receiving and acquiring SPS signals 360 via an SPS antenna 362. The processor 310 may include one or more intelligent hardware devices, e.g., a central processing unit (CPU), a microcontroller, an application specific integrated circuit (ASIC), etc. The processor 310 may comprise multiple processors (e.g., including a general-purpose/application processor, a DSP, a modem processor, a video processor, and/or a sensor processor as shown in FIG. 2). The memory 311 is a non-transitory storage medium that may include random access memory (RAM)), flash memory, disc memory, and/or read-only memory (ROM), etc. The memory 311 stores the software 312 which may be processor-readable, processor-executable software code containing instructions that are configured to, when executed, cause the processor 310 to perform various functions described herein. Alternatively, the software 312 may not be directly executable by the processor 310 but may be configured to cause the processor 310, e.g., when compiled and executed, to perform the functions. The description may refer only to the processor 310 performing a function, but this includes other implementations such as where the processor 310 executes software and/or firmware. The description may refer to the processor 310 performing a function as shorthand for one or more of the processors contained in the processor 310 performing the function. The description may refer to the TRP 300 performing a function as shorthand for one or more appropriate components of the TRP 300 (and thus of one of the BSs 110a, 110b, 114) performing the function. The processor 310 may include a memory with stored instructions in addition to and/or instead of the memory 311. Functionality of the processor 310 is discussed more fully below.

The transceiver 315 may include a wireless transceiver 340 and a wired transceiver 350 configured to communicate with other devices through wireless connections and wired connections, respectively. For example, the wireless transceiver 340 may include a transmitter 342 and receiver 344 coupled to one or more antennas 346 for transmitting (e.g., on one or more uplink channels) and/or receiving (e.g., on one or more downlink channels) wireless signals 348 and transducing signals from the wireless signals 348 to wired (e.g., electrical and/or optical) signals and from wired (e.g., electrical and/or optical) signals to the wireless signals 348. Thus, the transmitter 342 may include multiple transmitters that may be discrete components or combined/integrated components, and/or the receiver 344 may include multiple receivers that may be discrete components or combined/integrated components. The wireless transceiver 340 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 350 may include a transmitter 352 and a receiver 354 configured for wired communication, e.g., with the network 140 to send communications to, and receive communications from, the LMF 120, for example. The transmitter 352 may include multiple transmitters that may be discrete components or combined/integrated components, and/or the receiver 354 may include multiple receivers that may be discrete components or combined/integrated components. The wired transceiver 350 may be configured, e.g., for optical communication and/or electrical communication.

The configuration of the TRP 300 shown in FIG. 3 is an example and not limiting of the disclosure, including the claims, and other configurations may be used. For example, the description herein discusses that the TRP 300 is configured to perform or performs several functions, but one or more of these functions may be performed by the LMF 120 and/or the UE 200 (i.e., the LMF 120 and/or the UE 200 may be configured to perform one or more of these functions).

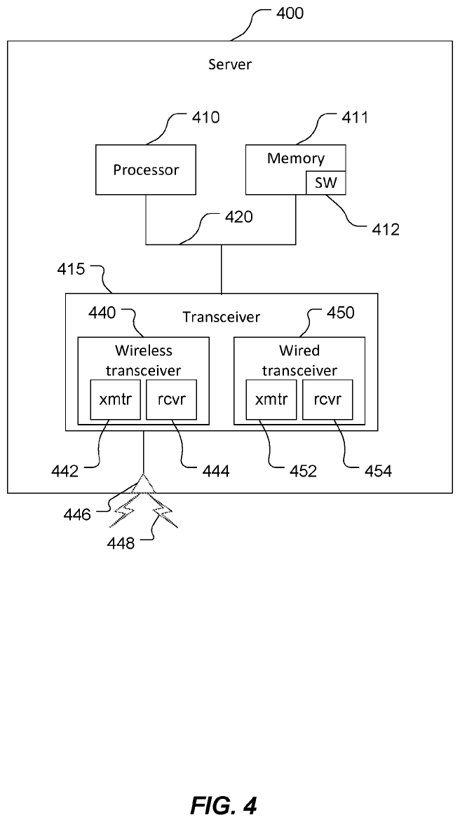

Referring also to FIG. 4, an example of the server 400 comprises a computing platform including a processor 410, memory 411 including software (SW) 412, and a transceiver 415. The processor 410, the memory 411, and the transceiver 415 may be communicatively coupled to each other by a bus 420 (which may be configured, e.g., for optical and/or electrical communication). One or more of the shown apparatus (e.g., a wireless interface) may be omitted from the server 400. The processor 410 may include one or more intelligent hardware devices, e.g., a central processing unit (CPU), a microcontroller, an application specific integrated circuit (ASIC), etc. The processor 410 may comprise multiple processors (e.g., including a general-purpose/application processor, a DSP, a modem processor, a video processor, and/or a sensor processor as shown in FIG. 2). The memory 411 is a non-transitory storage medium that may include random access memory (RAM)), flash memory, disc memory, and/or read-only memory (ROM), etc. The memory 411 stores the software 412 which may be processor-readable, processor-executable software code containing instructions that are configured to, when executed, cause the processor 410 to perform various functions described herein. Alternatively, the software 412 may not be directly executable by the processor 410 but may be configured to cause the processor 410, e.g., when compiled and executed, to perform the functions. The description may refer only to the processor 410 performing a function, but this includes other implementations such as where the processor 410 executes software and/or firmware. The description may refer to the processor 410 performing a function as shorthand for one or more of the processors contained in the processor 410 performing the function. The description may refer to the server 400 (or the LMF 120) performing a function as shorthand for one or more appropriate components of the server 400 (e.g., the LMF 120) performing the function. The processor 410 may include a memory with stored instructions in addition to and/or instead of the memory 411. Functionality of the processor 410 is discussed more fully below.

The transceiver 415 may include a wireless transceiver 440 and a wired transceiver 450 configured to communicate with other devices through wireless connections and wired connections, respectively. For example, the wireless transceiver 440 may include a transmitter 442 and receiver 444 coupled to one or more antennas 446 for transmitting (e.g., on one or more downlink channels) and/or receiving (e.g., on one or more uplink channels) wireless signals 448 and transducing signals from the wireless signals 448 to wired (e.g., electrical and/or optical) signals and from wired (e.g., electrical and/or optical) signals to the wireless signals 448. Thus, the transmitter 442 may include multiple transmitters that may be discrete components or combined/integrated components, and/or the receiver 444 may include multiple receivers that may be discrete components or combined/integrated components. The wireless transceiver 440 may be configured to communicate signals (e.g., with the UE 200, one or more other UEs, and/or one or more other devices) according to a variety of radio access technologies (RATs) such as 5G New Radio (NR), GSM (Global System for Mobiles), UMTS (Universal Mobile Telecommunications System), AMPS (Advanced Mobile Phone System), CDMA (Code Division Multiple Access), WCDMA (Wideband CDMA), LTE (Long-Term Evolution), LTE Direct (LTE-D), 3GPP LTE-V2X (PC5), IEEE 802.11 (including IEEE 802.11p), WiFi, WiFi Direct (WiFi-D), Bluetooth®, Zigbee etc. The wired transceiver 450 may include a transmitter 452 and a receiver 454 configured for wired communication, e.g., with the network 135 to send communications to, and receive communications from, the TRP 300, for example. The transmitter 452 may include multiple transmitters that may be discrete components or combined/integrated components, and/or the receiver 454 may include multiple receivers that may be discrete components or combined/integrated components. The wired transceiver 450 may be configured, e.g., for optical communication and/or electrical communication.

The configuration of the server 400 shown in FIG. 4 is an example and not limiting of the disclosure, including the claims, and other configurations may be used. For example, the wireless transceiver 440 may be omitted. Also or alternatively, the description herein discusses that the server 400 is configured to perform or performs several functions, but one or more of these functions may be performed by the TRP 300 and/or the UE 200 (i.e., the TRP 300 and/or the UE 200 may be configured to perform one or more of these functions).

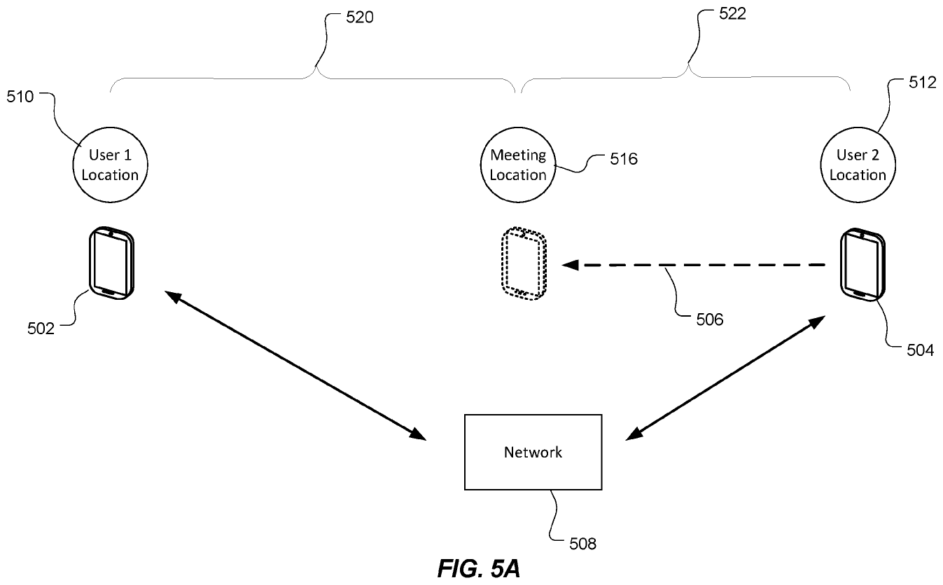

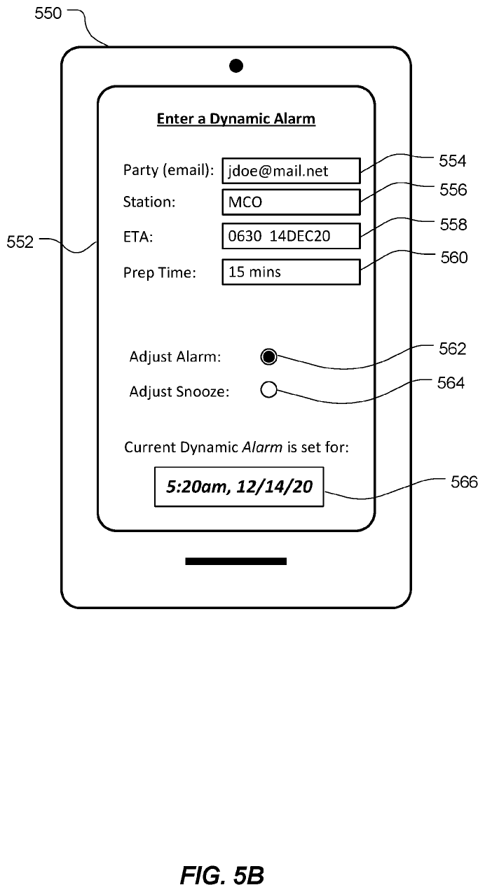

Referring to FIG. 5A, with further references to FIGS. 1-4, an example use case diagram for a dynamic alarm based on a location of a mobile user is shown. The use case in FIG. 5A includes a first mobile device 502 at a first location 510, and a second mobile device 504 at a second location 512. The first mobile device 502 and the second mobile device 504 may include some or all of the components shown in FIG. 2, such that the UE 200 may be an example of the first and the second mobile devices 502, 504. The first mobile device 502 and the second mobile device 504 are associated with respective first and second users (not shown in FIG. 5A). The first and second mobile devices 502, 504 are configured to utilize various satellite and terrestrial position-determining techniques (e.g., satellite-based positioning, cellular-based positioning, WiFi-based positioning, Blue-tooth-based positioning, sensor-based positioning, or any combinations thereof). For example, the mobile devices 502, 504 may include an SPS receiver 217. Other terrestrial position-determination techniques such as RTT, multi-RTT, OTDOA (also called TDOA and including UL-TDOA and DL-TDOA), Enhanced Cell Identification (E-CID), DL-AoD, UL-AoA, etc. may be used. RTT uses a time for a signal to travel from one entity to another and back to determine a range between the two entities. The range, plus a known location of a first one of the entities and an angle between the two entities (e.g., an azimuth angle) can be used to determine a location of the second of the entities. In multi-RTT (also called multi-cell RTT), multiple ranges from one entity (e.g., a mobile device 502, 504) to other entities (e.g., TRPs) and known locations of the other entities may be used to determine the location of the one entity. In TDOA techniques, the difference in travel times between one entity and other entities may be used to determine relative ranges from the other entities and those, combined with known locations of the other entities may be used to determine the location of the one entity. Angles of arrival and/or departure may be used to help determine a location of an entity. For example, an angle of arrival or an angle of departure of a signal combined with a range between devices (determined using signal, e.g., a travel time of the signal, a received power of the signal, etc.) and a known location of one of the devices may be used to determine a location of the other device. The angle of arrival or departure may be an azimuth angle relative to a reference direction such as true north. The angle of arrival or departure may be a zenith angle relative to directly upward from an entity (i.e., relative to radially outward from a center of Earth). E-CID uses the identity of a serving cell, the timing advance (i.e., the difference between receive and transmit times at the mobile device), estimated timing and power of detected neighbor cell signals, and possibly angle of arrival (e.g., of a signal at the mobile device from the base station or vice versa) to determine a location of the mobile device. In TDOA, the difference in arrival times at a receiving device of signals from different sources along with known locations of the sources and known offset of transmission times from the sources are used to determine the location of the receiving device.

The first mobile device 502 and the second mobile device 504 are configured to communicate with a network 508. The network 508 may include one or more of the components of the communication system 100. The network 508 may be configured to determine and provide location information to the mobile devices 502, 504. For example the LMF 120 may be configured to compute the location of the second mobile device 504 based on measurements received by the second mobile device 504.

In operation, the second mobile device 504 is on a trajectory 506 moving towards a meeting location 516. For example, the trajectory 506 may be a bus route, a train track, a roadway, or other paths between the second mobile device 504 and the meeting location 516. The meeting location 516 may represent a station, airport, parking lot, or other predesignated location where the first and second users will rendezvous. The first user may enter an initial alarm into the first mobile device 502 based on the time the second user is expected to arrive at the meeting location 516. The initial alarm may be based on the amount of time the first user will need to arrive at the meeting location 516.

The second mobile device 504, or another network resource, is configured to determine an estimated time of arrival (ETA) at the meeting location 516. In an example, the ETA may be based on a remaining distance 522 and the velocity of the mobile device 504. The velocity may be based on input from the SPS receiver 217, the IMU 270, or other sensors 213. In an example, the ETA may be based on network resources such as a route planning application and/or associated application interface (e.g., RouteXL, Google, Waze, etc.). The second mobile device 504, or a network resource, may be configured to periodically (e.g., 1, 2, 5, 10, 30 mins, etc.) update the ETA based in part on the current location of the second mobile device 504. The first mobile device 502 may be configured to access the updated ETA information. In an example, the updated ETA may be provided to the first mobile device 502 via a messaging protocol (e.g., SMS). The first mobile device 502 may be configured to periodically pull the updated ETA information from the network 508.

In an embodiment, the updated ETA information may be stored in the memory 211 and the processor 230 may modify the initial alarm time based on the updated ETA information. For example, if the ETA indicates the second user will arrive an hour late, the initial alarm may be reset to an hour later. Conversely, if the ETA indicates the second user will be 45 minutes early, the initial alarm may be set to activate 45 minutes earlier. In an embodiment, the alarm function on the first mobile device may have a snooze function and the updated ETA may be used to modify a snooze time value of the snooze function. The alarm time and/or snooze time value may be updated periodically based on the updates to the ETA. In an example, a minimum change threshold value (e.g., 5, 10, 20, 30 mins, etc.) may be used before modifying the alarm time. That is, the alarm time will not change unless the difference between the updated ETA value and the current alarm time is greater than the threshold value.

In addition to the updated ETA values, the alarm time on the first mobile device 502 may also consider a pick-up distance 520 between the first location 510 and the meeting location 516. For example, if the meeting location 516 is a train station, a route planning application may be used to determine the travel time from the first location 510 to the meeting location 516. Thus, a new alarm time may be based on the updated ETA and the time required for the first user to arrive at the meeting location 516 at the ETA time. For example, if the second user is scheduled to arrive at the meeting location 516 at 6:00 am, the first user may set an alarm on the first mobile device 502 for 5:30 am based on knowledge that the traffic between the first location 510 and the meeting location 516 is light at that time of the morning (e.g., before the rush-hour commute). During the evening, the first mobile device 502 may receive an updated ETA from the second mobile device 504 via the network 508 indicating that the second user will not arrive at the meeting location 516 until 8:30 am (i.e., a 2 hour and 30 minute delay). Upon obtaining the updated ETA, the first mobile device 502 may be configured to access a route planning service (e.g., Waze Planned Drive) to determine an estimated drive time between the first location 510 and the meeting location 516. Since 8:30 am is during the morning rush-hour, the travel time is expected to be about an hour. In an example, the first mobile device may be configured to adjust the alarm from 5:30 am to 7:30 am to compensate for both the updated ETA and expected increase in travel time. The new alarm may also include a user defined preparation time (e.g., 10, 15, 30 mins, etc.) such that the adjusted alarm is based on the updated ETA, expected travel time, and the preparation time. In another example, the initial 5:30 am alarm may be activated at the designated time, but a snooze function may indicate the updated ETA and recommend snoozing until 7:30 based on traffic concerns. The snooze time may also incorporate the user defined preparation time.

Referring to FIG. 5B, with further reference to FIGS. 1-5A, an example user interface on a mobile device 550 for entering a dynamic alarm is shown. The mobile device 550 may be the first mobile device 502 is FIG. 5A. The mobile device 550 includes a display 552 as a user interface 216. The data fields and objects depicted in FIG. 5B are examples only and not limitations as other data fields and objects may also be used in the user interface. In an example, the user interface for entering a dynamic alarm includes a party field 554, a station field 556, an ETA field 558, a preparation time field 560, an adjust alarm object 562, an adjust snooze object 564, and a dynamic alarm indication field 566. The party field 554 may be used to associate another user with the dynamic alarm. Continuing the example above, an email address or other contact information (e.g., name, phone number, etc.) for the second user may be entered. The party field 554 may be used to associate the dynamic alarm with that party and enable sharing of position information. The station field 556 may be used to indicate an expected rendezvous location such as a train station, airport, bus station, parking lot, address, lat/long, or other physical location such as the meeting location 516. The station field 556 may include other information such as a train, bus or flight numbers associated with a vehicle the party is travelling aboard. The station field 556 may be used with asset/vehicle tracking servers to determine ETA's for public and private transportation vehicles (e.g., ferries, flights, trains, buses, limos, ride share, taxis, UBER, LYFT, etc.) to obtain ETA updates. In an example the station field 556 may indicate the first location 510 (i.e., the first user's location) when the second user is planning to arrive at the first location 510 directly rather than at the meeting location 516.

The ETA field 558 may be entered by the user or obtained from the network 508 and indicates the estimated date and/or time the party (e.g., the party field 554) will arrive at the station or other designated location (e.g., the station field 556). The ETA field 558 may be updated based on the current location of the party as well as other events (e.g., weather, traffic, mechanical, etc.) as reported by a vehicle-tracking or routing service (e.g., flight tracker, Waze, etc.). The preparation time field 560 may be a user defined time period indicating additional preparation time the user may require (e.g., time required to shower, dress, eat, etc.) before meeting the party. The preparation time may also be set to adjust for parking time, and/or baggage handling delays, or other time factors based on the specific use case. The adjust alarm object 562 and the adjust snooze object 564 may be associated with one or more data fields and configured to capture the user's desire for an updated alarm time and/or an updated snooze time based on the ETA updates.

The dynamic alarm indication field 566 provides a visual indication of the current dynamic alarm activation time. For example, the time indicated in the dynamic alarm indication field 566 may be based on the ETA field 558, the preparation time field 560 and an expected travel time between the current location of the mobile device 550 and the station field 556 (i.e., the rendezvous location). In an example, if the adjust snooze object 564 is selected, the dynamic alarm indication field 566 may be used to indicate a snooze time value in addition to the current alarm time. The mobile device 550 is configured to activate an alarm (e.g., sound, lights, display, etc.) based on the dynamic alarm indication field 566. The mobile device 550 may be configured to track and maintain multiple dynamic alarms for different parties, meeting locations, and ETA times, or combinations of these fields.

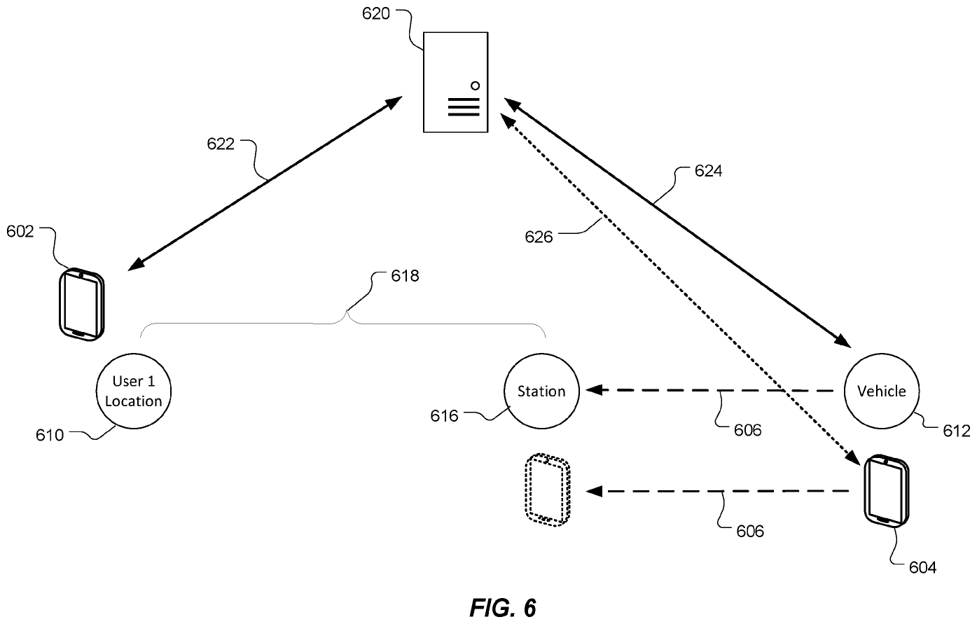

Referring to FIG. 6, with further reference to FIGS. 1-5B, an example use case diagram for a dynamic alarm based on web server data is shown. The use case includes a first user with a first mobile device 602, and a second user with a second mobile device 604. The first mobile device 602 and the second mobile device 604 may include some or all of the components shown in FIG. 2, and may be examples of the UE 105. The first and second users are assumed to be in possession of the respective first and second mobile devices 602, 604 and are not shown in FIG. 6. The first mobile device 602 is configured to communicate with a web server 620 via a first communication path 622. The web server 620 is an example of a server 400. The first communication path 622 may include one or more elements of the communication system 100. The web server 620 may include one or more public or proprietary data structures and application interfaces configured to provide asset/vehicle tracking and routing information to users. For example, the web server 620 may be an airline flight tracking application, ride-sharing tracker (e.g., UBER, LYFT tracking) or other routing web services (e.g., RouteXL, Google Waze, etc.). The web server 620 may include a REST API, or similar protocol, and is configured to respond to queries with ETA and travel time information. The web server may provide information to the mobile device 602 in known formats such as XML, JSON, CSV, etc.

In operation, the second user and the second mobile device 604 may be traveling in a moving vehicle 612 on a route 606 to a station 616. The vehicle 612 is in communication with the web server 620 via a second communication link 624. The second communication link 624 may include elements of the communication system 100 or it may be based on other networked technology. For example, when the vehicle 612 is an aircraft, the second communication link 624 may be a proprietary communication protocol to provide flight tracking and ETA information to the web server 620 via the Internet or other wide area networks. The vehicle 612 may provide location updates to the web server 620 as it proceeds along the route 606 and the web server 620 may be configured to generate and provide an updated ETA to the first mobile device 602. In an example, the second mobile device 604 may be configured to communicate with the web server 620 via a third communication link 626. The third communication link may be a cellular network such as the communication system 100. The second mobile device 604 may be configured to provide periodic location updates to the web server 620 via the third communication link 626.

The first user may enter a dynamic alarm into the first mobile device 602 such that the dynamic alarm includes the name, or other identification information, of the second user in the party field 554. In an example, the first mobile device 602 may query the web server 620 using the party field 554 and receive location information and time information based on the last reported location of the second mobile device 604. The dynamic alarm may include a station field 556 and/or a flight number (or other field associated with the vehicle 612) and the first mobile device 602 may query the web server 620 based on the flight number to obtain location and updated ETA information. The location information and/or updated ETA information may be used to compute a dynamic alarm or snooze value, such as depicted in the dynamic alarm indication field 566. In an example, the dynamic alarm may also be based in part on a pick-up distance 618 between the first location 610 and the station 616. That is, the dynamic alarm may include determining the estimated travel time from the first location 610 to the station 616 to allow the user to arrive at the station 616 at the time the vehicle 612 (and the second user) arrive at the station.

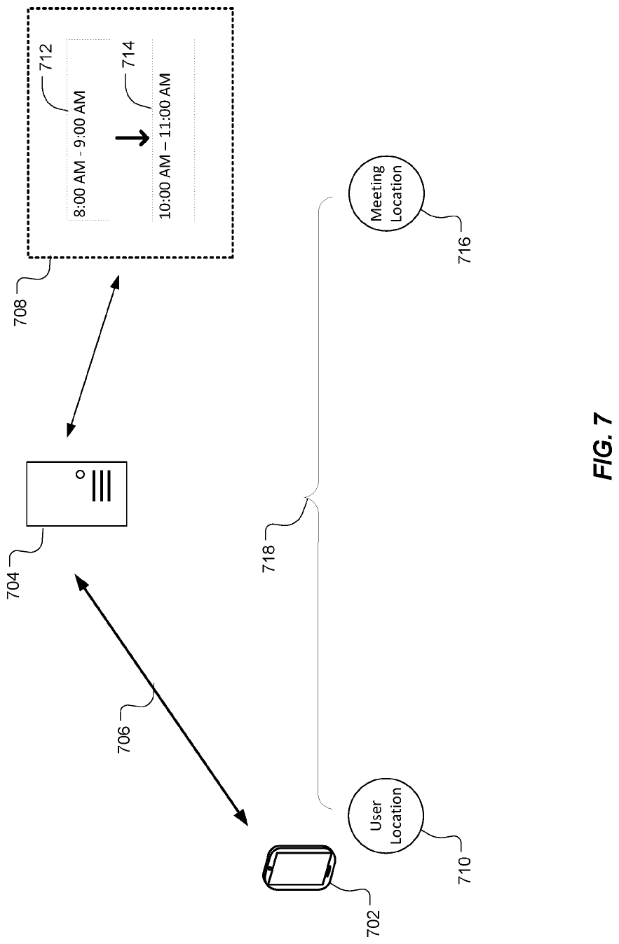

Referring to FIG. 7, with further reference to FIGS. 1-5B, an example use case diagram for a dynamic alarm based on schedule updates is shown. The use case includes a mobile device 702 and user location 710. The mobile device 702 is an example of a UE 105 and is configured to communicate with a server 704 via communication link 706. The communication link 706 may include one or more components of the communication system 100. The server 704 is an example of a server 400 and may be a cloud-based system such as Microsoft Azure Cloud configured with a schedule management application 708 such as MS Outlook. The schedule management application 708 may include event objects such as a meeting invitation 712. The mobile device 702 may be configured to communicate with the server 704 via the Internet and a local version of the schedule management application 708 may be configured to execute on the mobile device 702 while synchronizing with the server 704.

In operation, a user may enter a dynamic alarm based on an event object in the schedule management application 708. The party field 554 may represent a meeting ID value, the station field 556 may represent a meeting location 716, and the ETA field may represent a meeting start time (i.e., 8:00 am). The dynamic alarm on the mobile device may be based on the meeting start time as well as the estimated distance 718 between the user location 710 and the meeting location 716. That is, the mobile device 702 may utilize a route planning application (e.g., Google Waze) to determine the time required to travel from the user location 710 to the meeting location 716. The user location 710 may be based on the current location of the mobile device 702 or another location as specified by the user. For an Sam start time, the predicted travel time may be a relatively short period because the traffic is lower at that time of the morning as compared to a later start time. For example, if the meeting invitation 712 is updated to a 10:00 am start time in a meeting update 714, then the expected travel time from the user location 710 to the meeting location 716 will increase due to increased traffic.

The mobile device 702 is configured to monitor the schedule management application 708 for updates to the event objects. For example, MS Flow or other software applications may be used to detect updates to objects in the schedule management application 708. In this example, when the meeting invitation 712 is updated to 10:00 am, the mobile device 702 is configured to access the route planning application to determine the estimated travel time to the meeting location 716. The dynamic alarm may be updated based on the change in start time and the corresponding impact on travel time. For example, the two-hour delay in the meeting time (i.e., from Sam to 10 am) may correspond only to a change of an hour in the dynamic alarm because the later meeting time will require more travel time due to higher traffic later in the morning. The dynamic alarm may also include the preparation time field 560. In an example, the dynamic alarm may include an updated snooze time based on the change in meeting time and the revised travel time.

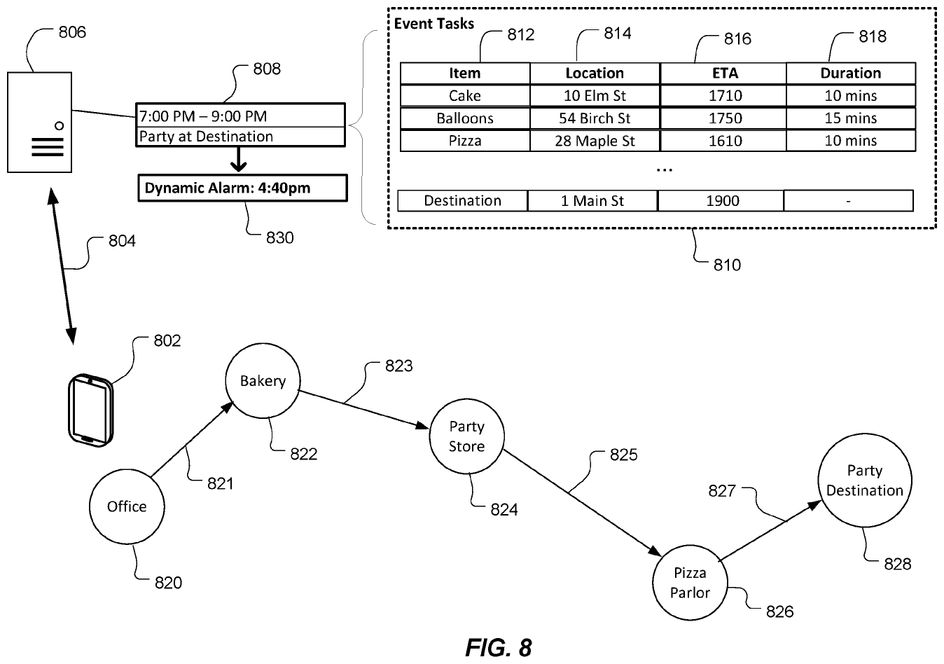

Referring to FIG. 8, with further reference to FIGS. 1-7, an example use case diagram for a dynamic alarm based on an event task list is shown. The use case includes a mobile device 802 configured to communicate with a server 806 via a communication link 804. The mobile device 802 may include some or all of the components shown in FIG. 2 and is an example of a UE 105. The server 806 may include one or more of the components of the server 400 such that the server 400 may be an example of the server 806. The communication link 804 and the server 806 may be part of the communication system 100. In an example, the mobile device 802 is configured to communicate with the server 806 via the Internet or other wide area networks. The mobile device 802 may include a schedule management application (e.g., MS Outlook, Gmail, Apple Mail) configured to receive appointment and task information from a user. In an example, the user's schedule data may also persist on the server 806 (e.g., cloud-based solution). The user may create a schedule object 808 including an event start time and a destination (e.g., address, user location). The schedule object 808 may be associated with one or more event tasks 810 entered by the user. The event tasks may include an item field 812, a location field 814, and ETA field 816 and a duration field 818. The schedule object 808 and the event tasks 810 may persist in the memory 211 of the mobile device 802, or on the memory 411 on the server 806.

In operation, the user may enter a schedule object 808 and the associated event tasks 810 into the mobile device 802 or other computing devices (not shown in FIG. 8). The initial entry of the event tasks 810 may include only a list of items 812 that the user wants to pick-up while in-route to a destination 828 in the schedule object 808. For example, referring to FIG. 8, the schedule object 808 is associated with a party at a destination which begins at 7:00 μm. The user is responsible for bringing a cake, balloons and pizzas to the party. The user may enter each of the items into the event tasks 810. The mobile device 802, or the server 806, may be configured to interact with a cloud platform (e.g., Google Maps Platform Store Locator) to identify one or more stores which carry the items. In this example, the cloud platform can be queried with the list of items and the query results may include a list of stores which stock the items. In an example, the query results may be filtered based on the current location of the mobile device and the location of the destination 828 such that the stores between the mobile device 802 and the destination 828 are given priority. The stores that stock multiple items in the event tasks 810 may also be given priority. The user may be given an option to select a store for each of the items 812. The cloud platform may return a list of stores based on optimized route planning Continuing the example in FIG. 8, the user selects three locations to visit on the way to the party destination 828. The locations to visit include a Bakery 822 on Elm St., a Party Store 824 on Birch St., and a Pizza Parlor 826 on Maple St. The cloud based platform may determine a first route 821 from the Office 820 to the Bakery 822, a second route 823 from the Bakery 822 to the Party Store 824, a third route 825 from the Party Store 824 to the Pizza Parlor 826, and a fourth route 827 from the Pizza Parlor 826 to the destination 828. The cloud platform may determine an estimated travel time for each of the routes 821, 823, 825, 827 and the ETA field 816 of the event tasks may be updated based on the estimated travel times. The user may enter a duration time for each stop in the duration field 818 and the ETA values 816 may be updated accordingly. A dynamic alarm 830 may be generated based on the original event time (i.e., 7:00 pm) in view of the estimated travel time for each of the routes 821, 823, 825, 827 and the duration times in the duration fields 818. In this example, the dynamic alarm 830 is set for 4:40 pm to indicate the time the user should leave the office 820 at that time to complete the tasks and arrive at the destination 828 on time. The dynamic alarm 830 may be periodically updated throughout the day (e.g., every 1, 5, 10, 30 mins etc.) based on revised travel time estimates.

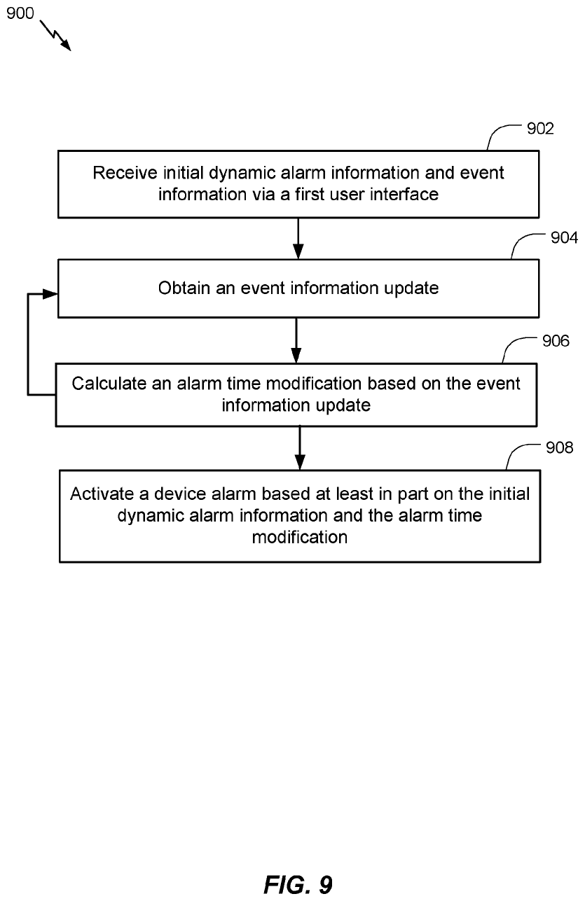

Referring to FIG. 9, with further reference to FIGS. 1-8, a method 900 of determining a dynamic alarm includes the stages shown. The method 900 is, however, an example only and not limiting. The method 900 may be altered, e.g., by having stages added, removed, rearranged, combined, performed concurrently, and/or having single stages split into multiple stages. For example, one or more stages may occur before, and/or one or more stages may occur after, the stages shown in FIG. 9. A mobile device 502 may be a means for implementing the method 900.

At stage 902, the method 900 includes receiving initial dynamic alarm information and event information via a first user interface. The user interface 216 and the processor 230 may be a means for receiving the initial dynamic alarm and event information. In an example, referring to FIG. 5B, a user may enter a dynamic alarm via the display 552 of the mobile device 550. Other computing devices may also be used to enter a dynamic alarm. The user may enter a party field 554 to associate the dynamic alarm with a person or event and an ETA field 558 as an initial alarm time. The user may also enter additional information associated with the alarm such as the station field 556 to indicate a potential rendezvous location (e.g., meeting location 516) and/or associate the dynamic alarm with a trackable object such as a plane, a train, a bus, a ride-sharing vehicle, etc. A preparation time field 560 may be included as additional time required in computing an alarm. In an example, the location of the mobile device 550, as obtained by satellite or terrestrial navigation techniques (e.g., satellite-based positioning, cellular-based positioning, WiFi-based positioning, Blue-tooth-based positioning, sensor-based positioning, or any combinations thereof), may be associated with a dynamic alarm.

At stage 904, the method 900 includes obtaining an event information update. The transceiver 215 and the processor 230 may be a means for obtaining an event information update. In an example, a device associated with the party identified in field 554, such as the second mobile device 504 in FIG. 5A, may provide periodic location updates to the network 508 as it moves towards the planned meeting location 516. A network resource, such as the LMF 120 or other server, may be configured to determine an updated ETA for the second mobile device 504 based on the received position information. In an example, the second mobile device 504 may utilize a route planning application (e.g., Waze) to periodically determine an updated ETA at the meeting location 516 and then provide the updated ETA to the first mobile device 502 via a messaging protocol (e.g., SMS, email). In an example, the first mobile device 502 may obtain ETA updates for the second mobile device 504 from a route planning web service (e.g., Waze, RouteXL) based in part on the party field 554. The updated ETA for the second mobile device 504 is an example of an event information update. In an example, an updated ETA for a vehicle 612 is an event information update. In another example, a schedule change in a schedule management application 708 may be an event information update.

At stage 906, the method 900 includes calculating an alarm time modification based on the event information update. The processor 230 may be a means for calculating the alarm time modification. In an example, the event information update is an updated ETA time associated with the arrival of the second user at the meeting location 516. The processor 230 is configured to modify the value of the dynamic alarm indication field 566 based on the updated ETA. For example, if the updated ETA is an hour later, then the dynamic alarm indication field 566 may be changed to an hour later. In an embodiment, calculating the alarm time modification may also be based on other conditions such as the expected traffic at the meeting location 516 at the updated ETA time. The mobile device 502 may be configured to obtain the expected travel time between the location of the first mobile device 502 and the meeting location 516 and the processor 230 may be configured to calculate the alarm time modification based on the event information update and the expected travel time. The processor 230 may also utilize the preparation time field 560 to compute the alarm time modification. In an embodiment, the alarm time modification may include a snooze time. For example, the processor 230 may keep the dynamic alarm time constant and compute a snooze time based on the event information update. The method 900 may periodically iterate back to stage 904 to determine further changes to the event information. For example, the first mobile device 502 may query a server on the network 508 to obtain updated location information for the second mobile device 504, updated vehicle-tracking information, updated schedule information, every 5, 10, 15 minutes etc. and then calculate a new alarm time modification in each iteration. In an example, the dynamic alarm indication field 566 is not updated unless the alarm time modification is larger than a threshold value of time (e.g., 5, 10, 20 mins, etc.) as compared to the current alarm value.

At stage 908, the method 900 includes activating a device alarm based at least in part on the initial dynamic alarm information and the alarm time modification. The processor 230 may be a means for activating a device alarm. The processor 230 may be configured to compare a current time with the dynamic alarm indication field 566 and activate one or more notification objects such as an audio file, flashing light, vibration mode, display messages, or combinations thereof. The dynamic alarm indication field 566 may be provided to a schedule management application as a reminder time and the schedule management application may then activate the alarm. In an example, activating the device alarm includes triggering a process flow such as sending a message or sending commands to one or more Internet of Things (IoT) devices. That is, activating the device alarm may include triggering IoT devices such as bedroom speakers, room lights, television, coffee pot, or other networked devices in a smart home. In an example, activating the device alarm includes activating the device alarm based on the initial dynamic alarm information and presenting a snooze option based on the alarm time modification. Upon completion of the snooze time, the device alarms may be reactivated. During the snooze period, the method 900 may continue to iterate to stages 904 and 906 and provide updated snooze notifications based on further event information updates.

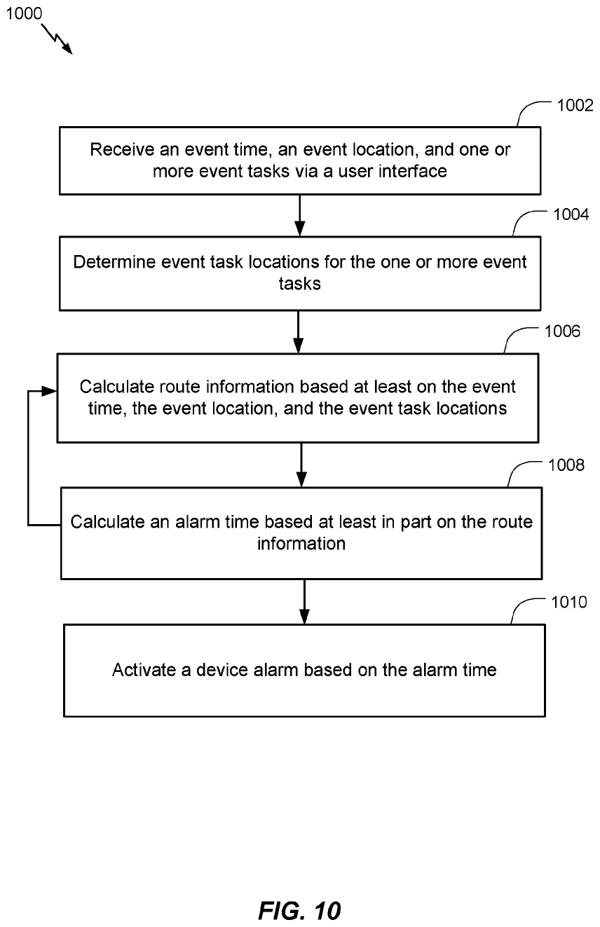

Referring to FIG. 10, with further reference to FIGS. 1-8, a method 1000 of calculating a dynamic alarm based on route information includes the stages shown. The method 1000 is, however, an example only and not limiting. The method 1000 may be altered, e.g., by having stages added, removed, rearranged, combined, performed concurrently, and/or having single stages split into multiple stages. For example, one or more stages may occur before, and/or one or more stages may occur after, the stages shown in FIG. 10. A mobile device 802 may be a means for implementing the method 1000.

At stage 1002, the method 1000 includes receiving an event time, an event location and one or more event tasks via a user interface. The user interface 216 and the processor 230 may be a means for receiving the event information. Referring to the use case in FIG. 8, a user may enter a schedule object 808 into the mobile device, or other networked computing system, including an event time (i.e., 7:00 pm) and an event location (i.e., Destination 828). The schedule object 808 may be part of a schedule management application such as MS Outlook. One or more event tasks 810 may also be associated with the schedule object 808. In an example, one or more of the event tasks 810 may include an item field 812 indicating an item the user desires to bring to the event. In an example, the event tasks may be assigned by another user or system such as a web-based invitation management application (e.g., evite.com) and imported into, or otherwise associated with, the user's event tasks 810.

At stage 1004, the method 1000 includes determining event task locations for the one or more event tasks. The transceiver 215 and the processor 230 may be a means for determining the event task locations. The event tasks 810 may include items 812 to be obtained by the user while in route to the destination 828. The mobile device 802 may utilize the transceiver 215 to access a web service and determine a location 814 for the items 812. For example, the Google Maps Platform Store Locator is a web service configured to provide locations associated with items. The results of the web service search, and user selection (if required), may be stored in the location field 814 in the event tasks 810. In an embodiment, the event task may have locations that are not associated with items to be obtained. For example, the event task may include dropping off an item at a location input by the user.

At stage 1006, the method 1000 includes calculating route information based at least on the event time, the event location, and the event task locations. The transceiver 215 and the processor 230 may be a means for calculating route information. The mobile device 802 is configured to access a route planning application (e.g., Waze, RouteXL) to determine the path and estimated travel time between the event task locations and the destinations. As depicted in the example in FIG. 8, the event task locations include the Bakery 822, the Party Store 824 and the Pizza Parlor 826. Each of the routes 821, 823, 825, 827 have an estimated travel time which may be saved in the memory 211. The order of the event locations along the routes may be based on route optimization provided by the route planning application (e.g., shortest, fastest, fewest tolls, etc.) or other considerations such as keeping the pizza warm (i.e., it will be picked up last).

At stage 1008, the method 1000 includes calculating an alarm time based at least in part on the route information. The processor 230 may be a means for calculating the alarm time. The estimated travel times in the route information calculated at stage 1006 may be subtracted from the event time received at stage 1002 to determine an alarm time. In an example, the user may provide duration information for each location in the duration field 818. The total duration time may also be incorporated into the alarm calculation. The resulting dynamic alarm 830 may be stored in an alarm field in the schedule object 808 (e.g., MeetingItem.ReminderTime in the MS Outlook object model). The alarm time may be stored in the memory 211 and used as a trigger by other applications on the mobile device 802. The method 1000 may periodically iterate back to stage 1006 to update the route information and subsequently recalculate the alarm time.

At stage 1010, the method 1000 includes activating a device alarm based on the alarm time. The processor 230 may be a means for activating a device alarm. The processor 230 may be configured to compare a current time with the dynamic alarm 830 and activate one or more notification objects such as an audio file, flashing light, vibration mode, display messages, or combinations thereof. The device alarm may be activated based on the functionality of a schedule management application. For example, the dynamic alarm 830 may be saved to a remind time field in the schedule object 808, and the schedule management application is configured to provide notifications or alerts based on the remind time. In an example, the activating a device alarm includes triggering a process flow such as sending a message or sending commands to one or more Internet of Things (IoT) devices.

Other examples and implementations are within the scope of the disclosure and appended claims. For example, due to the nature of software and computers, functions described above can be implemented using software executed by a processor, hardware, firmware, hardwiring, or a combination of any of these. Features implementing functions may also be physically located at various positions, including being distributed such that portions of functions are implemented at different physical locations. For example, one or more functions, or one or more portions thereof, discussed above as occurring in the servers 400 (e.g., the LMF 120), 620, 704, and 806 may be performed by other servers, such as the TRP 300.

As used herein, the singular forms “a,” “an,” and “the” include the plural forms as well, unless the context clearly indicates otherwise. For example, “a processor” may include one processor or multiple processors. The terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Also, as used herein, “or” as used in a list of items prefaced by “at least one of” or prefaced by “one or more of” indicates a disjunctive list such that, for example, a list of “at least one of A, B, or C,” or a list of “one or more of A, B, or C” means A or B or C or AB or AC or BC or ABC (i.e., A and B and C), or combinations with more than one feature (e.g., AA, AAB, ABBC, etc.).

Substantial variations may be made in accordance with specific requirements. For example, customized hardware might also be used, and/or particular elements might be implemented in hardware, software (including portable software, such as applets, etc.) executed by a processor, or both. Further, connection to other computing devices such as network input/output devices may be employed.

The systems and devices discussed above are examples. Various configurations may omit, substitute, or add various procedures or components as appropriate. For instance, features described with respect to certain configurations may be combined in various other configurations. Different aspects and elements of the configurations may be combined in a similar manner. Also, technology evolves and, thus, many of the elements are examples and do not limit the scope of the disclosure or claims.

Components, functional or otherwise, shown in the figures and/or discussed herein as being connected or communicating with each other are communicatively coupled unless otherwise noted. That is, they may be directly or indirectly connected to enable communication between them.

A wireless communication system is one in which communications are conveyed wirelessly, i.e., by electromagnetic and/or acoustic waves propagating through atmospheric space rather than through a wire or other physical connection. A wireless communication network may not have all communications transmitted wirelessly but is configured to have at least some communications transmitted wirelessly. Further, the term “wireless communication device,” or similar term, does not require that the functionality of the device is exclusively, or evenly primarily, for communication, or that the device be a mobile device, but indicates that the device includes wireless communication capability (one-way or two-way), e.g., includes at least one radio (each radio being part of a transmitter, receiver, or transceiver) for wireless communication.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the scope of the disclosure.

As used herein, unless otherwise stated, a statement that a function or operation is “based on” an item or condition means that the function or operation is based on the stated item or condition and may be based on one or more items and/or conditions in addition to the stated item or condition.

The terms “processor-readable medium,” “machine-readable medium,” and “computer-readable medium,” as used herein, refer to any medium that participates in providing data that causes a machine to operate in a specific fashion. Using a computing platform, various processor-readable media might be involved in providing instructions/code to processor(s) for execution and/or might be used to store and/or carry such instructions/code (e.g., as signals). In many implementations, a processor-readable medium is a physical and/or tangible storage medium. Such a medium may take many forms, including but not limited to, non-volatile media and volatile media. Non-volatile media include, for example, optical and/or magnetic disks. Volatile media include, without limitation, dynamic memory.

A statement that a value exceeds (or is more than or above) a first threshold value is equivalent to a statement that the value meets or exceeds a second threshold value that is slightly greater than the first threshold value, e.g., the second threshold value being one value higher than the first threshold value in the resolution of a computing system. A statement that a value is less than (or is within or below) a first threshold value is equivalent to a statement that the value is less than or equal to a second threshold value that is slightly lower than the first threshold value, e.g., the second threshold value being one value lower than the first threshold value in the resolution of a computing system.

Implementation examples are described in the following numbered clauses:

1. A method of providing a dynamic alarm with a mobile device, comprising:

receiving initial dynamic alarm information and event information via a first user interface;

obtaining an event information update;

calculating an alarm time modification based on the event information update; and

activating a device alarm based at least in part on the initial dynamic alarm information and the alarm time modification.

2. The method of clause 1 wherein the event information includes identification information associated with a second user.

3. The method of either clauses 1 or 2 wherein the event information includes an indication of a rendezvous location.

4. The method of clause 3 further comprising determining an estimated travel time from a location of a first device associated with a first user to the rendezvous location, wherein the alarm time modification is based in part on the estimated travel time.

5. The method of any of clauses 1-4 wherein the event information includes vehicle-tracking information associated with a vehicle.

6. The method of any of clauses 1-5 wherein the event information is associated with a schedule object in a schedule management application.

7. The method of any of clauses 1-6 wherein the event information update includes an estimated time of arrival based on a current location of a second device associated with a second user.

8. The method of any of clauses 1-7 wherein the event information update includes an estimated time of arrival for a vehicle.

9. The method of any of clauses 1-8 wherein the event information update includes a schedule change in a schedule object in a schedule management application.

10. The method of any of clauses 1-9 wherein calculating the alarm time modification includes adding a preparation time value.

11. The method of any of clauses 1-10 wherein calculating the alarm time modification includes calculating a snooze time value based on the initial dynamic alarm information and the event information update, and wherein activating the device alarm includes providing a snooze option via the first user interface based on the snooze time value.

12. The method of any of clauses 1-11 wherein activating the device alarm includes sending a command to one or more internet of things (IoT) devices.

13. An apparatus, comprising:

a memory;

at least one processor operably coupled to the memory and configured to:

receive initial dynamic alarm information and event information via a first user interface;

obtain an event information update;

calculate an alarm time modification based on the event information update; and

activate a device alarm based at least in part on the initial dynamic alarm information and the alarm time modification.

14. The apparatus of clauses 13 wherein the event information includes identification information associated with a second user.

15. The apparatus of either clause 13 or 14 wherein the event information includes an indication of a rendezvous location.

16. The apparatus of clause 15 wherein the at least one processor is further configured to determine an estimated travel time from a location of a first device associated with a first user to the rendezvous location, wherein the alarm time modification is based in part on the estimated travel time.

17. The apparatus of any of clauses 13-16 wherein the event information update includes an estimated time of arrival based on a current location of a second device associated with a second user.

18. The apparatus of any of clauses 13-17 wherein the at least one processor is further configured to calculate a snooze time value based on the initial dynamic alarm information and the event information update and provide a snooze option to a user based on the snooze time value.

19. An apparatus for providing a dynamic alarm, comprising:

means for receiving initial dynamic alarm information and event information via a first user interface;

means for obtaining an event information update;

means for calculating an alarm time modification based on the event information update; and

means for activating a device alarm based at least in part on the initial dynamic alarm information and the alarm time modification.

20. The apparatus of clause 19 wherein the event information includes identification information associated with a second user.

21. The apparatus of either of clauses 19 or 20 wherein the event information includes an indication of a rendezvous location.

22. The apparatus of clause 21 further comprising means for determining an estimated travel time from a location a first device associated with a first user to the rendezvous location, wherein the alarm time modification is based in part on the estimated travel time.

23. The apparatus of any of clauses 19-22 wherein the event information includes vehicle-tracking information associated with a vehicle.

24. The apparatus of any of clauses 19-23 wherein the event information is associated with a schedule object in a schedule management application.

25. The apparatus of any of clauses 19-24 wherein the event information update includes an estimated time of arrival based on a current location of a second device associated with a second user.

26. The apparatus of any of clauses 19-25 wherein the event information update includes an estimated time of arrival for a vehicle.

27. The apparatus of any of clauses 19-26 wherein the event information update includes a schedule change in a schedule object in a schedule management application.

28. The apparatus of any of clauses 19-27 wherein the means for calculating the alarm time modification includes means for adding a preparation time value.

29. The apparatus of any of clauses 19-28 wherein the means for calculating the alarm time modification comprises means for calculating a snooze time value based on the initial dynamic alarm information and the event information update, and wherein the means for activating the device alarm includes means for providing a snooze option to a user based on the snooze time value.

30. A non-transitory processor-readable storage medium comprising processor-readable instructions to cause one or more processors to provide a dynamic alarm, comprising:

code for receiving initial dynamic alarm information and event information via a first user interface;

code for obtaining an event information update;

code for calculating an alarm time modification based on the event information update; and

code for activating a device alarm based at least in part on the initial dynamic alarm information and the alarm time modification.

31. A method of providing a dynamic alarm, comprising:

receiving an event time, an event location and one or more event tasks via a user interface;

determining event task locations for the one or more event tasks;

calculating route information based at least on the event time, the event location, and the event task locations;

calculating an alarm time based at least in part on the route information; and

activating a device alarm based on the alarm time.

32. The method of clause 31 wherein the one or more event tasks include an item and determining the event task locations includes determining a location associated with the item.

33. The method of either of clauses 31 or 32 wherein receiving the one or more event tasks via the user interface includes receiving one or more event tasks from an invitation management application that are assigned to a user.

34. The method of any of clauses 31-33 wherein calculating the route information includes receiving estimated travel times from a route planning application based on the event time, the event location and the event task locations.

35. The method of any of clauses 31-34 wherein one or more of the event task locations is associated with a duration time and calculating the alarm time is based at least in part on the route information and the duration time.

36. The method of any of clauses 31-35 wherein activating the device alarm includes providing the alarm time to an alarm field to a schedule object in a schedule management application.

37. An apparatus, comprising:

a memory;

at least one processor operably coupled to the memory and configured to:

receive an event time, an event location and one or more event tasks via a user interface;

determine event task locations for the one or more event tasks;

calculate route information based at least on the event time, the event location, and the event task locations;

calculate an alarm time based at least in part on the route information; and

activate a device alarm based on the alarm time.

38. The apparatus of clause 37 wherein the one or more event tasks include an item and determining the event task locations includes determining a location associated with the item.

39. The apparatus of either of clauses 37 or 38 wherein the at least one processor is further configured to receive the one or more event tasks from an invitation management application that are assigned to a user.

40. The apparatus of any of clauses 37-39 wherein the at least one processor is further configured to receive estimated travel times from a route planning application based on the event time, the event location and the event task locations.

41. The apparatus of any of clauses 37-40 wherein one or more of the event task locations is associated with a duration time and the at least one processor is further configured to calculate the alarm time based at least in part on the route information and the duration time.

42. The apparatus of any of clauses 37-41 wherein the at least one processor is further configured to provide the alarm time to an alarm field to a schedule object in a schedule management application.

43. An apparatus for providing a dynamic alarm, comprising:

means for receiving an event time, an event location and one or more event tasks via a user interface;

means for determining event task locations for the one or more event tasks;

means for calculating route information based at least on the event time, the event location, and the event task locations;

means for calculating an alarm time based at least in part on the route information; and

means for activating a device alarm based on the alarm time.

44. The apparatus of clause 43 further comprising means for receiving one or more event tasks from an invitation management application that are assigned to a user.

45. The apparatus of either of clause 43 or 44 further comprising means for receiving estimated travel times from a route planning application based on the event time, the event location and the event task locations.

46. A non-transitory processor-readable storage medium comprising processor-readable instructions configured to cause one or more processors to provide a dynamic alarm, comprising:

code for receiving an event time, an event location and one or more event tasks via a user interface;

code for determining event task locations for the one or more event tasks;

code for calculating route information based at least on the event time, the event location, and the event task locations;

code for calculating an alarm time based at least in part on the route information; and

code for activating a device alarm based on the alarm time.

47. The non-transitory processor-readable storage medium of clause 46 further comprising code for receiving one or more event tasks from an invitation management application that are assigned to a user.

48. The non-transitory processor-readable storage medium of either of clause 46 or 47 further comprising code for receiving estimated travel times from a route planning application based on the event time, the event location and the event task locations.

1. A method of providing a dynamic alarm with a mobile device, comprising:
receiving initial dynamic alarm information and event information via a first user interface;
obtaining an event information update;
calculating an alarm time modification based on the event information update; and
activating a device alarm based at least in part on the initial dynamic alarm information and the alarm time modification.

2. The method of claim 1 wherein the event information includes identification information associated with a second user.

3. The method of claim 1 wherein the event information includes an indication of a rendezvous location.

4. The method of claim 3 further comprising determining an estimated travel time from a location of a first device associated with a first user to the rendezvous location, wherein the alarm time modification is based in part on the estimated travel time.

5. The method of claim 1 wherein the event information includes vehicle-tracking information associated with a vehicle.

6. The method of claim 1 wherein the event information is associated with a schedule object in a schedule management application.

7. The method of claim 1 wherein the event information update includes an estimated time of arrival based on a current location of a second device associated with a second user.

8. The method of claim 1 wherein the event information update includes an estimated time of arrival for a vehicle.

9. The method of claim 1 wherein the event information update includes a schedule change in a schedule object in a schedule management application.

10. The method of claim 1 wherein calculating the alarm time modification includes adding a preparation time value.

11. The method of claim 1 wherein calculating the alarm time modification includes calculating a snooze time value based on the initial dynamic alarm information and the event information update, and wherein activating the device alarm includes providing a snooze option via the first user interface based on the snooze time value.

12. The method of claim 1 wherein activating the device alarm includes sending a command to one or more internet of things (IoT) devices.

13. An apparatus, comprising:
a memory;
at least one processor operably coupled to the memory and configured to:
receive initial dynamic alarm information and event information via a first user interface;
obtain an event information update;
calculate an alarm time modification based on the event information update; and
activate a device alarm based at least in part on the initial dynamic alarm information and the alarm time modification.

14. The apparatus of claim 13 wherein the event information includes identification information associated with a second user.

15. The apparatus of claim 13 wherein the event information includes an indication of a rendezvous location.

16. The apparatus of claim 15 wherein the at least one processor is further configured to determine an estimated travel time from a location of a first device associated with a first user to the rendezvous location, wherein the alarm time modification is based in part on the estimated travel time.

17. The apparatus of claim 13 wherein the event information update includes an estimated time of arrival based on a current location of a second device associated with a second user.

18. The apparatus of claim 13 wherein the at least one processor is further configured to calculate a snooze time value based on the initial dynamic alarm information and the event information update and provide a snooze option to a user based on the snooze time value.

19. An apparatus for providing a dynamic alarm, comprising:
means for receiving initial dynamic alarm information and event information via a first user interface;
means for obtaining an event information update;
means for calculating an alarm time modification based on the event information update; and
means for activating a device alarm based at least in part on the initial dynamic alarm information and the alarm time modification.

20. The apparatus of claim 19 wherein the event information includes identification information associated with a second user.

21. The apparatus of claim 19 wherein the event information includes an indication of a rendezvous location.

22. The apparatus of claim 21 further comprising means for determining an estimated travel time from a location a first device associated with a first user to the rendezvous location, wherein the alarm time modification is based in part on the estimated travel time.

23. The apparatus of claim 19 wherein the event information includes vehicle-tracking information associated with a vehicle.

24. The apparatus of claim 19 wherein the event information is associated with a schedule object in a schedule management application.

25. The apparatus of claim 19 wherein the event information update includes an estimated time of arrival based on a current location of a second device associated with a second user.

26. The apparatus of claim 19 wherein the event information update includes an estimated time of arrival for a vehicle.

27. The apparatus of claim 19 wherein the event information update includes a schedule change in a schedule object in a schedule management application.

28. The apparatus of claim 19 wherein the means for calculating the alarm time modification includes means for adding a preparation time value.

29. The apparatus of claim 19 wherein the means for calculating the alarm time modification comprises means for calculating a snooze time value based on the initial dynamic alarm information and the event information update, and wherein the means for activating the device alarm includes means for providing a snooze option to a user based on the snooze time value.

30. A non-transitory processor-readable storage medium comprising processor-readable instructions to cause one or more processors to provide a dynamic alarm, comprising:
code for receiving initial dynamic alarm information and event information via a first user interface;
code for obtaining an event information update;
code for calculating an alarm time modification based on the event information update; and
code for activating a device alarm based at least in part on the initial dynamic alarm information and the alarm time modification.

31. A method of providing a dynamic alarm, comprising:
receiving an event time, an event location and one or more event tasks via a user interface;
determining event task locations for the one or more event tasks;
calculating route information based at least on the event time, the event location, and the event task locations;
calculating an alarm time based at least in part on the route information; and
activating a device alarm based on the alarm time.

32. The method of claim 31 wherein the one or more event tasks include an item and determining the event task locations includes determining a location associated with the item.

33. The method of claim 31 wherein receiving the one or more event tasks via the user interface includes receiving one or more event tasks from an invitation management application that are assigned to a user.

34. The method of claim 31 wherein calculating the route information includes receiving estimated travel times from a route planning application based on the event time, the event location and the event task locations.

35. The method of claim 31 wherein one or more of the event task locations is associated with a duration time and calculating the alarm time is based at least in part on the route information and the duration time.

36. The method of claim 31 wherein activating the device alarm includes providing the alarm time to an alarm field to a schedule object in a schedule management application.

37. An apparatus, comprising:
a memory;
at least one processor operably coupled to the memory and configured to:
receive an event time, an event location and one or more event tasks via a user interface;
determine event task locations for the one or more event tasks;
calculate route information based at least on the event time, the event location, and the event task locations;
calculate an alarm time based at least in part on the route information; and
activate a device alarm based on the alarm time.

38. The apparatus of claim 37 wherein the one or more event tasks include an item and determining the event task locations includes determining a location associated with the item.

39. The apparatus of claim 37 wherein the at least one processor is further configured to receive the one or more event tasks from an invitation management application that are assigned to a user.

40. The apparatus of claim 37 wherein the at least one processor is further configured to receive estimated travel times from a route planning application based on the event time, the event location and the event task locations.

41. The apparatus of claim 37 wherein one or more of the event task locations is associated with a duration time and the at least one processor is further configured to calculate the alarm time based at least in part on the route information and the duration time.

42. The apparatus of claim 37 wherein the at least one processor is further configured to provide the alarm time to an alarm field to a schedule object in a schedule management application.

43. An apparatus for providing a dynamic alarm, comprising:
means for receiving an event time, an event location and one or more event tasks via a user interface;
means for determining event task locations for the one or more event tasks;
means for calculating route information based at least on the event time, the event location, and the event task locations;
means for calculating an alarm time based at least in part on the route information; and
means for activating a device alarm based on the alarm time.

44. The apparatus of claim 43 further comprising means for receiving one or more event tasks from an invitation management application that are assigned to a user.

45. The apparatus of claim 43 further comprising means for receiving estimated travel times from a route planning application based on the event time, the event location and the event task locations.

46. A non-transitory processor-readable storage medium comprising processor-readable instructions configured to cause one or more processors to provide a dynamic alarm, comprising:
code for receiving an event time, an event location and one or more event tasks via a user interface;
code for determining event task locations for the one or more event tasks;
code for calculating route information based at least on the event time, the event location, and the event task locations;
code for calculating an alarm time based at least in part on the route information; and
code for activating a device alarm based on the alarm time.

47. The non-transitory processor-readable storage medium of claim 46 further comprising code for receiving one or more event tasks from an invitation management application that are assigned to a user.

48. The non-transitory processor-readable storage medium of claim 46 further comprising code for receiving estimated travel times from a route planning application based on the event time, the event location and the event task locations.
